(19) United States
(12) Patent Application Publication
(10) Pub. No.: US 2024/0257337 A1
(43) Pub. Date: Aug. 1, 2024

(54) METHOD AND SYSTEM FOR SURFACE DEFORMATION DETECTION

(71) Applicant: Abyss Solutions Pty Ltd, Sydney (AU)

(72) Inventors: Lloyd Noel WINDRIM, Sydney (AU); Eric Leonard FERGUSON, Sydney (AU); Toby Francis DUNNE, Sydney (AU); Yuze GONG, Sydney (AU); Suchet BARGOTI, Sydney (AU); Nasir AHSAN, Sydney (AU)

(73) Assignee: Abyss Solutions Pty Ltd, Sydney (AU)

(21) Appl. No.: 18/565,744

(22) PCT Filed: May 31, 2022
(86) PCT No.: PCT/AU2022/050527

§ 371 Date: Nov. 30, 2023

(30) Foreign Application Priority Data
May 31, 2021 (AU) 2021901624

(51) Int. Cl. G06T 7/00; G06T 7/11; G06T 7/73

(52) U.S. Cl. CPC G06T 7/001; G06T 7/11; G06T 7/75; G06T 2207/10028; G06T 2207/20036; G06T 2207/20081; G06T 2207/20084; G06T 2207/30164

(57) ABSTRACT

Disclosed is a method and system for detecting surface deformation of a production asset. The method and system may include receiving a point cloud for a surface of the production asset; determining a model surface for the production asset from the point cloud, the model surface being an estimate of a deformation free representation of the surface of the production asset, the model surface being determined from points in the point cloud including points representing a surface deformation; determining a distance between at least one point in the point cloud and the model surface; and outputting the distance.

### TECHNICAL FIELD

The present invention relates to automatic detection of physical features of objects, and particularly to method and systems for automatically detecting surface deformation.

### BACKGROUND

Fabric maintenance (FM) refers to processes or techniques whereby the integrity of assets are monitored and, when defects are detected, restored. Processes covered by FM include corrosion management operations, such as painting/coating programs, as well as other processes that are critical to assuring and extending the life of an asset. FM is an integral component of operations in the resource production industry, such as the oil and gas industry in which operators have to maintain numerous assets on offshore platforms for extended periods of time under challenging environmental conditions.

Traditionally, FM processes have required subject matter experts (SMEs) to conduct regular inspections of a site or production facility. The SMEs survey the site, take notes, and collect visual data. The data is then reviewed by the SMEs, typically at an office remote from the site, and organised into an inspection report with a summary of inspection findings. The output of the process is an FM plan for scheduling and executing more detailed inspection tasks or conducting maintenance work such as painting and repairs.

The effectiveness of an FM process may depend on the experience and personal opinion of the SMEs who undertake site surveys and review the collected data. For example, different SMEs may hold different views on the severity of a particular trace of corrosion, which in turn leads to sampling bias, variable results, and poor reproducibility. Critically, defects that are incorrectly characterised or detected may have a severely adverse impact on the operation of a production facility.

Moreover, physical surveys and manual review of the data is a time-consuming, labor-intensive process, and site operators can accrue large backlogs of FM, especially on sites with aging facilities.

There is a need for new or improved methods and/or systems of detecting physical defects or physical features in an object or a structure.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

One embodiment includes a method of detecting surface deformation of a production asset, the method comprising: receiving a point cloud for a surface of the production asset; determining a model surface for the production asset from the point cloud, the model surface being an estimate of a deformation free representation of the surface of the production asset, the model surface being determined from points in the point cloud including points representing a surface deformation; determining a distance between at least one point in the point cloud and the model surface; and outputting the distance.

In one embodiment, the distance between each point in the point cloud and the model is measured normal to the surface of the production asset.

In one embodiment, the point cloud for the surface of the production asset is located about a point on the production asset.

In one embodiment, the points in the point cloud are filtered to select points within a predetermined distance of the point.

In one embodiment, the method further comprises: smoothing points in the point cloud using locations of a plurality of neighbouring points in the point cloud.

In one embodiment, a distance is determined between each point in the point cloud and the model surface.

In one embodiment, the method further comprises: calculating a maximum distance between points in the point cloud and the model surface; and associating the maximum distance with the production asset.

In one embodiment, the model surface may be fitted to a curved surface.

In one embodiment, the model surface is parameterised polynomial model.

In one embodiment, the distance between the at least one point in the point cloud and the model surface is compensated for the model surface being determined from points in the point cloud including points representing the surface deformation.

In one embodiment, the distance is compensated independent of a location of the at least one point in the point cloud.

In one embodiment, the distance is compensated using a linear transform applied to an initial distance between the at least one point in the point cloud and the model surface.

In one embodiment, the received point cloud is for a non-planar surface of the production asset.

In one embodiment, the determined model surface is determined using a model selected from a plurality of models.

In one embodiment, the plurality of models includes at least two models selected from the set including a parameterised polynomial model, a piecewise polynomial model and a rigid shape defined by a set of parameters.

In one embodiment, each of the plurality of models is compared to the point cloud and the model is selected according to a best fit.

In one embodiment, outputting the distance further comprises: determining a maximum distance between point in the point cloud and the model surface; classifying the point cloud for the surface according to the maximum distance; and displaying the point cloud to a user according to the classification.

One embodiment includes a system for detecting surface deformation of a production asset comprising at least one processing system configured to: receive a point cloud for a surface of the production asset; determine a model surface for production asset from the point cloud, the model surface being an estimate of a deformation free representation of the surface of the production asset, the model surface being determined from points in the point cloud including points representing a surface deformation; and determine a distance between at least one point in the point cloud and the model surface; and output the distance.

In one embodiment, the distance between each point in the point cloud and the model is measured normal to the surface of the production asset.

In one embodiment, the point cloud for the surface of the production asset is located about a point on the production asset.

In one embodiment, the points in the point cloud are filtered to select points located within a predetermined distance of the point.

In one embodiment, the at least one processing system is further configured to: smooth points in the point cloud using locations of a plurality of neighbouring points in the point cloud.

In one embodiment, a distance is determined between each point in the point cloud and the model surface.

In one embodiment, the at least one processing system is further configured to: calculate a maximum distance between points in the point cloud and the model surface; and associating the maximum distance with the production asset.

In one embodiment, the model surface may be fitted to a curved surface.

In one embodiment, the model surface is parameterised polynomial model.

In one embodiment, the at least one processing system is further configured to, when outputting the distance: determine a maximum distance between point in the point cloud and the model surface; classify the point cloud for the surface according to the maximum distance; and display the point cloud to a user according to the classification.

In one embodiment, the distance between the at least one point in the point cloud and the model surface is compensated for the model surface being determined from points in the point cloud including points representing the surface deformation.

In one embodiment, the distance is compensated independent of a location of the point in the point cloud.

In one embodiment, the distance is compensated using a linear transform applied to an initial distance between at least one point in the point cloud and the model surface.

In one embodiment, the received point cloud is for a non-planar surface of the production asset.

In one embodiment, the determined model surface is determined using a model selected from a plurality of models.

In one embodiment, the plurality of models includes at least two models selected from the set including a parameterised polynomial model, a piecewise polynomial model and a rigid shape defined by a set of parameters.

In one embodiment, each of the plurality of models is compared to the point cloud and the model is selected according to a best fit.

### BRIEF DESCRIPTION OF FIGURES

At least one embodiment of the present invention is described, by way of example only, with reference to the accompanying figures.

Example embodiments are apparent from the following description, which is given by way of example only, of at least one non-limiting embodiment, described in connection with the accompanying figures.

FIG. 1 illustrates a block diagram of an example computer-implemented method of detecting physical features of objects;

FIG. 2 illustrates a block diagram of an example processing system;

FIG. 3 illustrates a block diagram of an example system for detecting physical features of objects;

FIG. 4 illustrates an example image obtained by a data capture module of the system of FIG. 3;

FIG. 5 illustrates an example flowchart of the operation of an image processing module of the system of FIG. 3;

FIG. 6 illustrates an example spherical image obtained by a data capture module of the system of FIG. 3;

FIG. 7 illustrates an example partitioning of a spherical image into multiple flat images;

FIG. 8 illustrates example images showing regions of corrosion identified by the system of FIG. 3;

FIG. 9 illustrates an example process whereby proximate regions of corrosion identified by the system of FIG. 3 are merged and regions with a small size are removed;

FIG. 10 illustrates an example flowchart of the operation of a 3D association module of the system of FIG. 3;

FIG. 11 illustrates an example flowchart of the operation of an operational database module of the system of FIG. 3;

FIG. 12 illustrates a table of regions of corrosion and a spatial heat map showing regions of corrosion identified by the system of FIG. 3;

FIG. 13 illustrates an example hierarchy of for ranking regions of corrosion identified by the system of FIG. 3;

FIG. 14 illustrates an example table showing equipment and a priority of inspection attributed by the system of FIG. 3;

FIG. 15 illustrates an example flowchart of the operation of a quality assurance module of the system of FIG. 3;

FIGS. 16A to D illustrates block diagram for a computer implemented method of surface deformation detection according to one embodiment;

FIGS. 17A to D illustrate a 3D point clouds of a surface deformation detection system according to one embodiment;

FIG. 18 illustrates a selection radius as used in the surface deformation detection system according to one embodiment;

FIG. 19 illustrates a 3D inspection window of the surface deformation detection system;

FIG. 20 illustrates an output of the surface deformation detection system according to one embodiment; and

FIG. 21 illustrates an output of the surface deformation detection system according to one embodiment.

### DETAILED DESCRIPTION

The following modes, given by way of example only, are described in order to provide a more precise understanding of the subject matter of an embodiment or embodiments. In the figures, incorporated to illustrate features of an example embodiment, like reference numerals are used to identify like parts throughout the figures.

Described is a surface deformation detection system that may be carried out as a method of detecting surface deformation of a production asset. A point cloud is received for a surface of the production asset, with each point in the point cloud having associated data. A model surface for the point cloud is then determined, the model surface being an estimate of a deformation free representation of the surface. Next, a difference between at least one point in the point cloud and the model surface is determined before the difference is output.

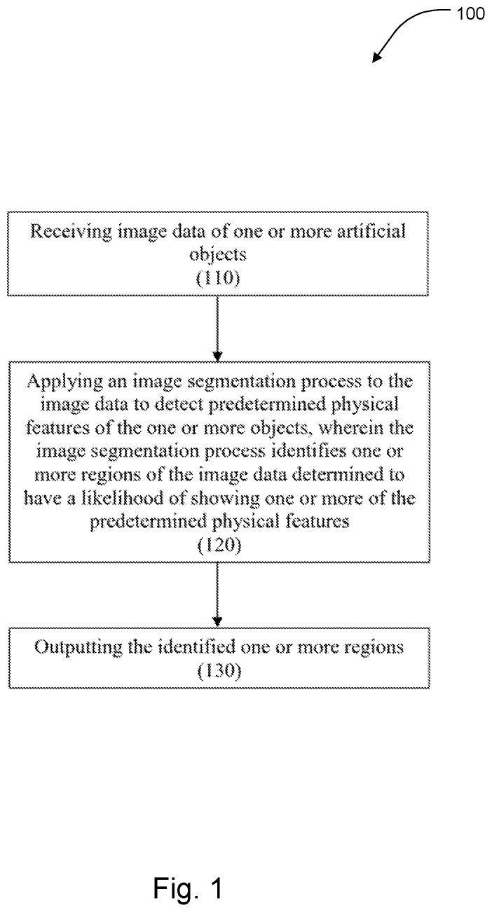

Referring to FIG. 1, there is illustrated a computer-implemented method 100. Method 100 may be a method for detecting or identifying physical features, such as defects, of one or more artificial objects.

Method 100 comprises a step 110 of receiving or obtaining image data of one or more artificial objects. The image data may be visual image data, thermal image data, hyperspectral image data, two-dimensional (2D) depth image data, or any other type of image data.

In some examples, the image data comprises one or more images, including a plurality of images, with each image showing at least one object (or part of an object) of the one or more objects. In some examples, at least two images of the plurality of images show a same object of the one or more objects. That is, one or more of the objects may be represented in multiple images, for example, from different perspectives or views (e.g. a top view, a front view, a side view, or any other view) and/or with different image resolutions, so that different images may provide different data about the same object. By receiving images representing multiple viewpoints of the same object, it may be possible to reduce or minimise gaps in the image data relating to that object. If multiple images are obtained representing similar views of an object, but with different resolutions, the images may be merged to improve the quality of image data for the object.

An object may be any tangible article, thing, or item. An object may be unitary (i.e. formed by a single entity), or composite, or compound (i.e. formed by several parts or elements). An object may have any size or shape, and it may comprise a structure (such as a building) or part of a structure (such as a wall, a floor, a door, stairs, or a railing). In some examples, the object is a pipe, a pipeline, a cable, or a valve. In some examples, the object is a production asset, an item or piece of equipment (including mechanical, electrical, or electromechanical equipment), such as a crane or a pump. In some examples, the object is any asset on an offshore platform, such as an oil or gas platform or offshore drilling rig, an onshore production facility, a construction site, a bridge, a dam, a canal, a chemical plant, a ship or other shipping sector facility, or any other site or facility. In some examples, the object is an entire offshore platform. An artificial object is any object made or manufactured by human beings, such as a product.

In some examples, the images represent a scene, which may comprise various elements such as equipment, structure, flooring, personnel, or objects more generally. A scene may represent a complex variety of objects.

In some examples, the images comprise one or more photographs of the objects. In some examples, the images comprise one or more frames of a video of the objects. In some examples, the images comprise one or more 2D images of the objects. In some examples, the images comprises one or more three-dimensional (3D) images of the objects. In some examples, the images comprise one or more spherical images of the objects.

The images may be associated with location or position data (e.g. geo-tagging data), which may be received, along with the image data, to provide an indication of the viewpoint or perspective represented by each image.

Method 100 further comprises a step 120 of applying an image segmentation process to the image data to detect predetermined physical features of the one or more artificial objects, wherein the image segmentation process identifies one or more regions of the image data determined to have a likelihood of showing, indicating, or having a visual indication of one or more of the predetermined physical features. In some examples, step 120 involves the detection, identification, and categorisation of predetermined physical features in the image data.

A physical feature may be a colour, texture, shape, or characteristic of an object. In some examples, a physical feature comprises an element connected to or associated with the object, which may be distinct from the object itself, such as a tag or printed label attached to the object. In some examples, a physical feature is a physical defect of the object.

A defect may be any physical defect, fault, surface deformation or blemish of one or more objects, or any other mark indicative of a reduced performance or integrity of the object. In some examples, a defect is an external or surface defect that is visible on an exterior side of the object. In other examples, a defect is an internal defect that may manifest itself on an exterior side of the object. In some examples, the defect is corrosion (including active and inactive corrosion). In some examples, the defect is a crack or fracture. In some examples, the defect is a blister. In some examples, the defect is a bend. In some examples, the defect is a deformation. In some examples the defect may be a coat degradation in a coat of a surface such as paint.

In some examples, the image segmentation process determines a confidence factor for each region of the one or more regions. In some examples, the image segmentation process determines a confidence factor for each pixel or data point in a region or in the image data. The confidence factor may represent a likelihood of the presence of one or more of the predetermined physical features in the region identified by the image segmentation process. Regions having a confidence factor lower than a predetermined probability threshold may be automatically tagged as not having one of the predetermined physical features or may be sent to an operator for manual review.

In some examples, the image segmentation process determines severity metrics for the defects in the identified regions. A severity metric may represent a severity or significance of a defect. In some examples, the image segmentation process determines a severity/intensity factor for each region of the one or more regions. In some examples, the image segmentation process determines a severity factor of each pixel belonging to a fault, defect, or feature. For example, the image segmentation process may determine a severity factor of identified corrosion in a certain region, representing the severity of the corrosion in that region.

In some examples, the image segmentation process is implemented by a region-based segmentation process, a mathematical morphology segmentation, a genetic algorithm-based segmentation, an artificial neural network-based segmentation, a deep learning structure, or a combination of these.

A region may be an area, sector, or portion of the image data. Therefore, in some examples, a region is a part of an image, although a region may also comprise a whole image. A region may comprise one or more data points or pixels of the image data. In some examples, each region of the one or more regions comprises a plurality of pixels that are adjacent or spatially adjoining.

In some examples, prior to step 120, method 100 further comprises a step of processing images of the image data to emphasise, highlight, or accentuate visual indications of the predetermined physical features. This may be done in order to facilitate the identification of regions showing predetermined physical features in step 120. In some examples, processing the images may comprise applying undistortion filters, brightening the images, adjusting a contrast of the images, resizing the images to a predetermined image size, cropping the images to retain predetermined areas of the images, image smoothing, applying a normalisation operation, applying multiplication or convolution operation, applying a spatial filter, applying a geometrical transformation to the image data, or a combination of these.

Method 100 further comprises a step 130 of outputting the identified regions.

In some examples, prior to step 130, method 100 further comprises a step of merging or combining the two or more regions of the identified regions into a single or combined region. The step of merging two or more regions may be performed automatically, without any input or direction by a human operator. Two or more regions may be combined when the distance (e.g. the number of pixels, or true distances calculated using any 3D information) between them is below a predefined amount, so that regions that are found to be sufficiently near to each other are treated as a single region. The two or more regions may be combined using morphological operations. Then, at step 130, the single or combined region is output in place of two or more regions that were merged. This may increase the efficiency with which data is output by method 100.

In some examples, prior to step 130, any region of the one or more regions that has a size (e.g. a size calculated in terms of a number of pixels) smaller than a size threshold are discarded or otherwise disregarded so that they are not output by step 130. For example, regions having a size smaller than 100 pixels may not be output. This may increase the efficiency with which data is output by method 100, so that defects or physical features that are considered to be small or negligible (i.e. below a predefined size) are disregarded. The size threshold may be predefined or it may be defined dynamically. Moreover, the size threshold may be set manually or it may be calculated as a function of parameters such as range to scene, context of scene, type of image capture device, 3D information, or a combination of these or other parameters.

In some examples, method 100 further comprises a step of receiving metadata or additional data of the one or more objects. The metadata may be associated with the image data. The metadata may comprise data of different categories and/or different modalities (i.e. different types of data). In some examples, the metadata comprises spatial metadata, object identification metadata, defect identification metadata, and defect resolution metadata. In some examples, the spatial metadata comprises 3D spatial data specifying a location in 3D space for each pixel of the image data. In some examples, the spatial metadata comprises computer-aided design (CAD) data, such as a CAD model of the one or more objects, or a 3D LiDAR (light detection and ranging) scan or representation of the one or more objects, or any other 3D model or representation of the one or more objects. In some examples, the metadata comprises labels or tags of the one or more objects, such as data that specifies what object is represented by each pixel of the image data. The labels may provide information on the objects, such as their identity, their function, and their risk profiles. In some examples, the metadata comprises at least one of labels providing information on a defect type, defect category (e.g. corrosion label), labels identifying the one or more artificial objects, and a recommended or possible intervention for resolving a defect.

In some examples, method 100 further comprises steps of associating each region of the one or more regions with the metadata, aggregating the one or more regions based on characteristics or the categories of the metadata, and storing the aggregated one or more regions into a database of the predetermined physical features. The characteristics or categories of the metadata may comprise spatial, temporal, geometrical, or any other attribute of the metadata. The aggregation step may prioritize aggregation of certain categories of metadata. For example, if one of the identified regions is associated with multiple categories of metadata, method 100 may include prioritising one of these categories (e.g. computer aided design CAD spatial metadata) for aggregating the region.

In some examples, method 100 further comprises the steps of receiving risk profiles associated with the characteristics or categories of the metadata, ranking the one or more regions based on the risk profiles of the characteristics or categories of the metadata associated with each region of the one or more regions, and outputting a prioritisation table containing the one or more regions ranked based on the risk profiles of the characteristics or categories of the metadata associated with each region of the one or more regions.

In some examples, method 100 further comprises the step of receiving 3D spatial data (which may be the spatial metadata) of the one or more objects. The 3D spatial data may be associated with the image data. The 3D spatial metadata may comprise 3D spatial metadata of different modalities, such as CAD model metadata and 3D point cloud metadata. Method 100 may further comprise steps of aggregating image data representing different viewpoints or perspectives of a same object of the one or more objects based on the different modalities of the 3D spatial data, and generating a 3D representation of the one or more regions and the one or more structures using the aggregated image data and/or the 3D spatial data. For example, the image data may comprise multiple images of the same object from different viewpoints; by using multiple modalities of 3D spatial metadata as context for multi-view image processes, pixel regions of the images representing the same object or physical area may be aggregated.

In some examples, step 110 may receive 3D models or information of the one or more objects instead of, or in addition to, the image data. In this way, step 120 may deal directly with 3D models, which may facilitate the detection of certain kinds of physical features including defects, such as deformation. For example, a neural network may process 3D models (or 3D images) of the assets and return a degree of deformation (relative to an ideal or satisfactory shape) at each point on the 3D model. In another example, at step 110, 3D information is received and method 100 comprises a further step of converting the 3D data to a “depth map” comprising 2D image data and depth information (e.g. RGB colour channels plus a fourth channel representing depth), which is processed by the neural network.

In some examples, method 100 further comprises the step of automatically identifying regions of uncertainty. The regions of uncertainty may be regions in which the likelihood of showing one or more of the predetermined physical features is below a likelihood threshold, or regions having high entropy, or regions representing samples near decision boundaries of the image segmentation process. Method 100 may further comprise the steps of reviewing, by an operator, the regions of uncertainty, and, in response to the one or more regions not having been correctly identified by the image segmentation process (e.g. an identified region does not actually contain a predetermined physical feature), marking on the image data one or more corrected regions showing one or more predetermined physical features. Method 100 may further comprise a step of training the image segmentation process using the marked imaged data. In this way, the image segmentation process may be re-trained, or trained more than one time, effectively using the trained image segmentation process to inform the operator about which data may need to be marked for refining the operation of the image segmentation process.

In some examples, method 100 further comprises a step of generating one or more evaluation metrics or scores assessing the operation or impact of method 100, rather than machine learning criteria such as pixel perfect performance denoted by mean intersection-over-union (mIOU). In some examples, the evaluation metric is generated based on a determination of impact of detecting one or more predetermined physical features of the one or more objects, a severity classification of the one or more predetermined physical features, and errors in the identification or classification of the one or more regions, such as confusion between classes, misdetections and misfire rates when used by an operator to make decisions.

In some examples, determining the evaluation metric comprises determining an area of intersection or overlap between (i) a region of the one or more regions, and (ii) a region of the image data actually showing the one or more predetermined physical features predicted to be shown in the region of the one or more regions (i.e. the intersection of the predicted region of interest and the true region of interest). The area of intersection may be expressed as a percentage or a fraction of one of the two (or of both) intersecting regions. For example, if the identified region overlaps half of the actual region of the physical feature, the evaluation metric would be 50%. The area of intersection may be calculated for each region of the one or more regions, and an average or other statistical value may be calculated to assess an overall performance of the image segmentation process. This metric, which may be termed the “coverage rate” (further discussed below) may associate one detection or identified region with multiple anomalies, which can be a valid operational goal.

In some examples, the image segmentation process is trained by using a definition of a physical feature provided by a user. In some examples, the image segmentation process is trained by using image data showing predetermined physical features. In some examples, the image segmentation process is trained by using image data of the one or more objects in which predetermined physical features have been marked by a user.

In some examples, method 100 requires no manual feature extraction or human annotation of the image data, and the image segmentation process is an end-to-end process receiving nothing other than the raw image data to output the identified regions.

Therefore, method 100 may enable consistent quality of defect detection and may expedite and facilitate the process of defect detection or feature detection more generally.

In some examples, there is provided a system comprising at least one processing system. The system may be a system for detecting or identifying physical features, such as defects, of one or more artificial objects. The at least one processing system may be configured to receive or obtain image data of one or more artificial objects, and to apply an image segmentation process to the image data to detect predetermined physical features of the one or more artificial objects. The image segmentation process may be configured to identify one or more regions of the image data determined to have a likelihood of showing one or more of the predetermined physical defects. The at least one processing system may further be configured to output the identified one or more regions.

It will be appreciated that the term “processing system” may refer to any electronic processing device or system, or computing device or system, or combination thereof (e.g. computers, web servers, smart phones, laptops, microcontrollers, etc.), and may include a cloud computing system. The processing system may also be a distributed system. In general, processing/computing systems may include one or more processors (e.g. CPUs, GPUs), memory componentry, and an input/output interface connected by at least one bus. They may further include input/output devices (e.g. keyboard, displays, etc.). It will also be appreciated that processing/computing systems are typically configured to execute instructions and process data stored in memory (i.e. they are programmable via software to perform operations on data).

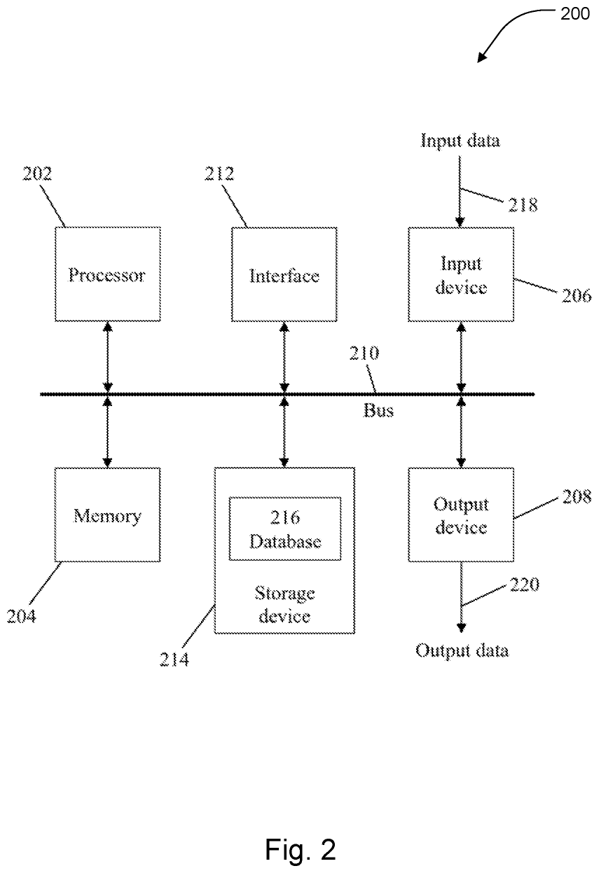

Referring to FIG. 2, there is illustrated an example processing system 200 suitable for implementing method 100 or a system for detecting defects. In particular, the processing system 200 generally includes at least one processor 202, or processing unit or plurality of processors, memory 204, at least one input device 206 and at least one output device 208, coupled together via a bus or group of buses 210. In certain embodiments, input device 206 and output device 208 could be the same device. An interface 212 can also be provided for coupling the processing system 200 to one or more peripheral devices, for example interface 212 could be a PCI card or PC card. At least one storage device 214 which houses at least one database 216 can also be provided. The memory 204 can be any form of memory device, for example, volatile or non-volatile memory, solid state storage devices, magnetic devices, etc. The processor 202 could include more than one distinct processing device, for example to handle different functions within the processing system 200.

Input device 206 receives input data 218 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 218 could come from different sources, for example keyboard instructions in conjunction with data received via a network. Output device 208 produces or generates output data 220 and can include, for example, a display device or monitor in which case output data 220 is visual, a printer in which case output data 220 is printed, a port for example a USB port, a peripheral component adaptor, a data transmitter or antenna such as a modem or wireless network adaptor, etc. Output data 220 could be distinct and derived from different output devices, for example a visual display on a monitor in conjunction with data transmitted to a network. A user could view data output, or an interpretation of the data output, on, for example, a monitor or using a printer. The storage device 214 can be any form of data or information storage means, for example, volatile or non-volatile memory, solid state storage devices, magnetic devices, etc.

In use, the processing system 200 is adapted to allow data or information to be stored in and/or retrieved from, via wired or wireless communication means, the at least one database 216. The interface 212 may allow wired and/or wireless communication between the processing unit 202 and peripheral components that may serve a specialised purpose. The processor 202 receives instructions as input data 218 via input device 206 and can display processed results or other output to a user by utilising output device 208. More than one input device 206 and/or output device 208 can be provided. It should be appreciated that the processing system 200 may be any form of terminal, server, specialised hardware, or the like.

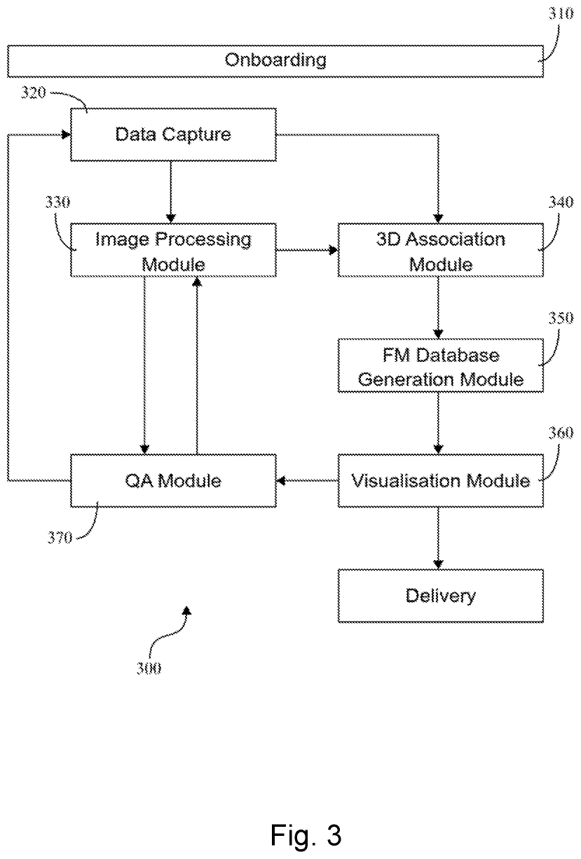

Referring to FIG. 3, there is illustrated an example system 300 for detecting physical features, such as defects, in one or more objects. System 300 may be configured to produce a complete digital representation, which is spatially accurate, and is available as a fly-through for operators to explore without being at the facility themselves. System 300 may be a corrosion management tool for fabric maintenance, and it may be deployed in commercial offshore projects for the oil and/or gas industry for the assessment of topside of oil platforms. System 300 may include a software service that consumes digital data of a production facility and returns a defect or fault database to facilitate asset management. The system 300 may also output intermediate results or receive data from other, connected systems. System 300 may also be deployed on “edge”, so as to be accessible through an edge device (e.g. a tablet computer or mobile device) when an operator is at the facility.

System 300 may include a client onboarding 310 process or module. This process establishes how the software will be tuned to integrate with a current client asset management workflow.

When delivering an automated inspection service for corrosion management and planning in the offshore industry, the output from the analytics may be aligned with the current operational workflow and procedures for particular clients. This involves feature-understanding from field subject matter experts and conversion of that understanding to a format the analytics model can digest. For example, an operator may need to make decisions on occurrences of heavy and moderate corrosion on an offshore platform. The onboarding stage would then capture the definition of heavy and moderate corrosion for the particular client, as the definitions may vary between clients, by unpacking current documentations on corrosion definition and conducting a series of questionnaires to capture the subject matter expert's (SME) interpretation on the corrosion definition. These questionnaires help evaluate fault definition and also capture any subjective variances between SMEs. The output from the questionnaire may then be used to tune the image processing module (described below) of system 300.

Additional onboarding 310 procedures may include designing health metrics for operational decisions. For example, one client may be interested in painting entire areas of an offshore platform, and therefore may need to know the total surface area of corrosion in a given area. Aggregated metrics will therefore be designed to reflect this. Another workflow may involve painting individual equipment components depending on how corroded they are. Therefore metric aggregation will be done component-wise.

In order to build a priority queue for facilitating work orders, client onboarding 310 may also include capturing risk profiles of the different equipment on the production facility. For example, corrosion on the thin pipelines carrying high value material poses a significantly higher risk than corrosion on the floor and railings. Therefore, as part of the onboarding process 310, all unique equipment tags may be collected and their risk profiles noted.

In some examples, client onboarding 310 also includes workflow integration beyond the inspection database generation. This includes establishing and integrating with existing operational processes, which can utilise the asset health information output from system 300 to make decisions. For example, the generated fault database can be integrated with existing client asset management software (such as Maximo®), which are used to generate, organise and execute work orders.

System 300 may further include a data capture 320 process or module. Data capture 320 may involve surveying offshore platforms comprehensively using cameras and/or 3D image capture technologies. Data capture 320 may be used for digital transformation of platforms, and its outputs may include flat and/or panoramic images, 3D point clouds, spatial metadata, localisation information for all data points, and/or corresponding CAD models of the assets with associated equipment tags.

System 300 may be configured to recommend particular data capture strategies and/or data quality performed by data capture process 320 for particular analytics.

In some examples, for inspection of an offshore platform, a 360-degree imaging camera, coupled with a laser system can be used to capture data systematically across the platform. For example, an offshore platform with multiple decks would have scan points positioned every 2 to 3 metres from each other. The output would then comprise multiple high-resolution spherical images which have a high dynamic range such that overexposure or underexposure of components is reduced or minimised. Furthermore, the density of the data capture may be selected to ensure maximum coverage and sufficient data resolution, and individual sections may be imaged from multiple perspectives.

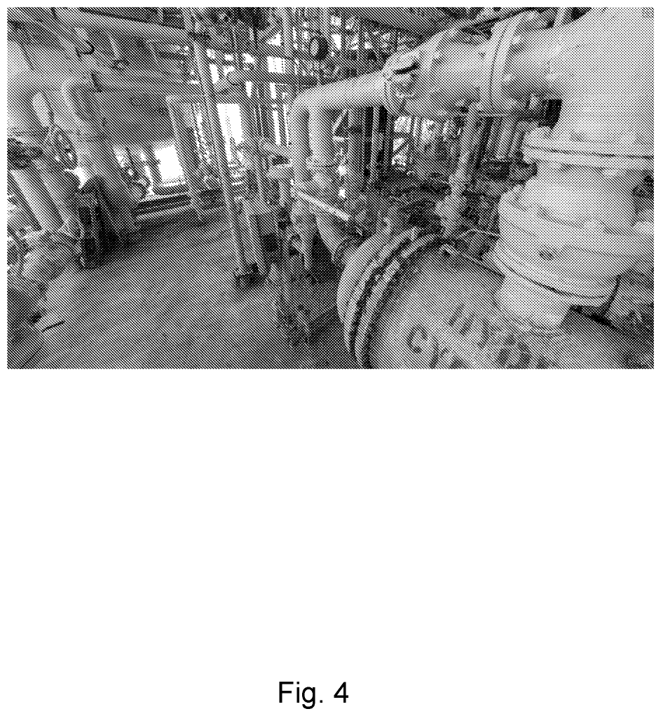

Each spherical image may be associated with positional and orientation information in a fixed platform reference frame. Alongside this, a 3D point cloud may be provided in the same reference frame. The reference frames across these data components may be shared, and they may further be the same as the reference frame with an up-to-date CAD model of the platform. Referring to FIG. 4, there is illustrated an example spherical image captured at an offshore production facility.

Referring again to FIG. 3, system 300 may further include an image processing module 330.

Image processing module 330 may be configured to gain an understanding of images captured during the data capture process 320. This understanding can include extracting regions of interest (ROIs) in an automated way, for example, by obtaining an understanding of what is occurring and where it is occurring in an image automatically. A region may be defined as one or more pixels that are connected spatially in some way.

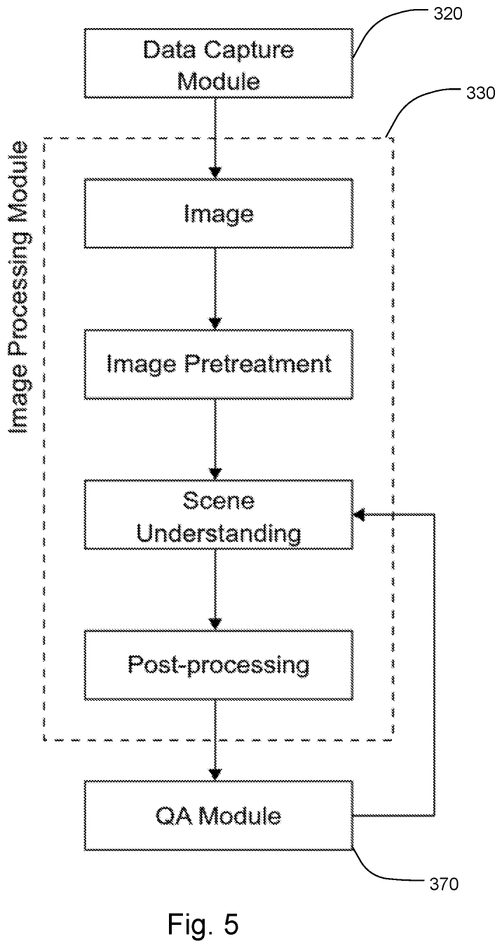

Referring to FIG. 5, there is illustrated an example flowchart showing the operation of image processing module 330, which will be further described next.

Image processing module 330 may perform a pretreatment on the image, such that ROIs are more easily distinguishable from other regions in the image. The pretreatment may include a process of image enhancing or transforming. For example, an image may be pretreated by applying undistortion filters, brightening, and then resizing.

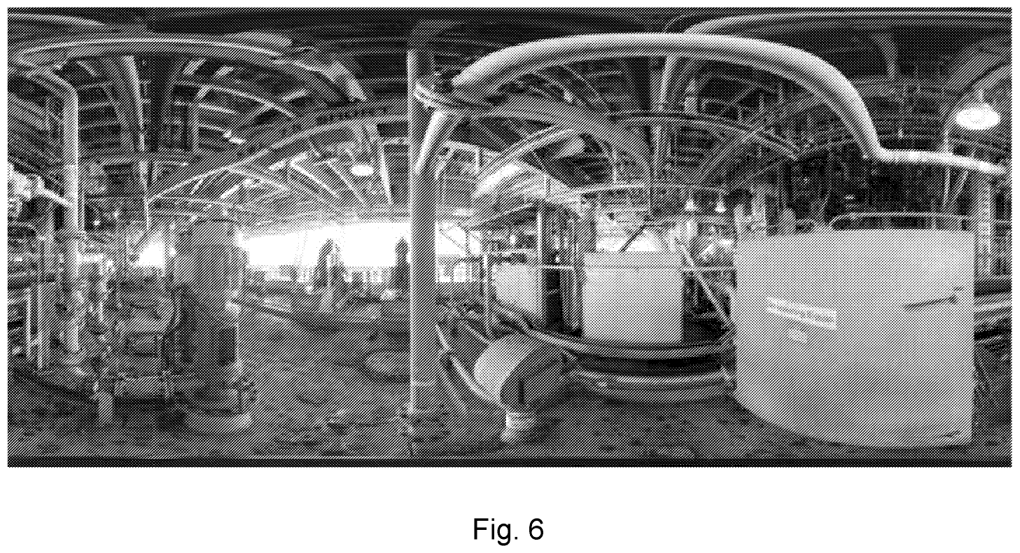

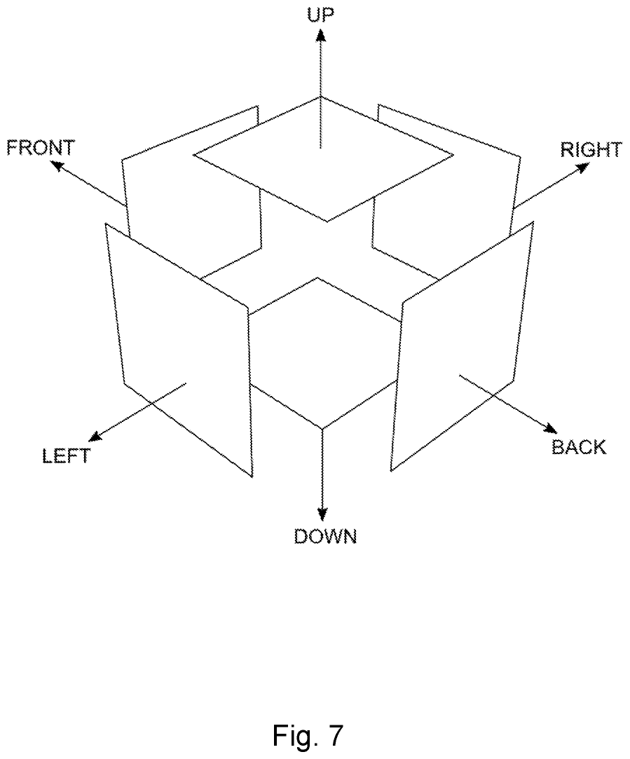

In some examples, a 360-degree imaging camera captures spherical images for inspection of an offshore platform (as illustrated in FIG. 6). These images are then divided into square sections (i.e. a cube-map split) and ‘flattened’ into 2D space, with undistortion filters applied (as illustrated in FIG. 7). Subsequently, each image is resized to a standard size of 4000 pixels by 4000 pixels, or any other size depending on image quality resolution, distance to object, and type of analytics algorithm being used. Each “cube face”, or projection of the spherical image, may then be processed by a scene understanding submodule.

Image processing module 330 may further perform scene understanding during which an image potentially including any number of ROIs may be identified based on an image segmentation technique. Image segmentation may be performed by recognising one or more characteristics or features of any number of pixels in the image. Image segmentation may refer to “recognition”, “classification”, “extraction”, “prediction”, “regression”, or any other process whereby some ROIs or some level of understanding is extracted automatically from regions in an image. Image segmentation can include region-based segmentation, mathematical morphology segmentation, genetic algorithm-based, artificial neural network-based image segmentation framework, or a combination of these processes. Exemplary characteristics or features may include texture, colours, contrast, brightness, or the like, or any combinations thereof in real space, or abstract combinations in feature space.

In some examples, pre-processed images from the image pre-treatment submodule are input through a neural network which performs image segmentation by predicting the severity of corrosion and substrate condition for each pixel and region in the image. The neural network is “trained” by studying sufficient images of example ROIs, in combination with regions of non-interest.

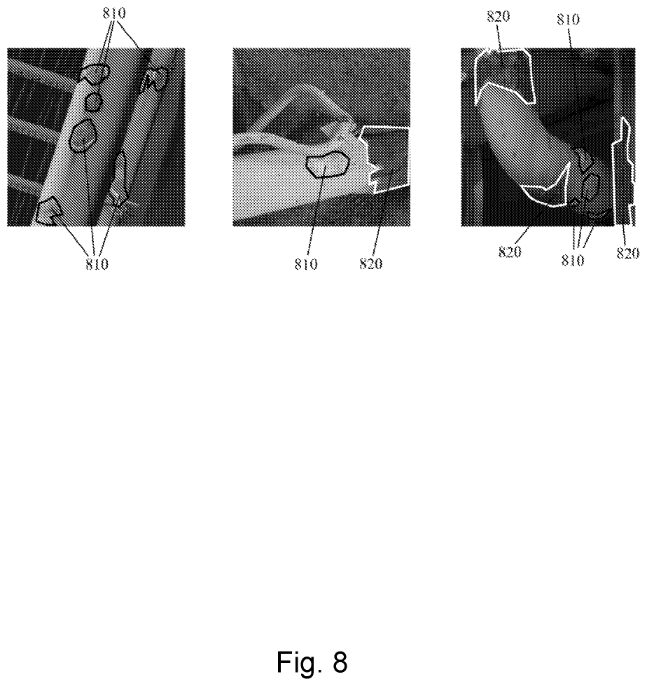

An example of corrosion identification results are shown in FIG. 8. In some examples, in the scene understanding submodule of image processing module 330, a neural network predicts regions and “classes” of corrosion on images, and, for each class, evaluates a strength of severity of corrosion indicative of the significance of that class, including regions of moderate corrosion 810 and regions of heavy corrosion 820.

Image processing module 330 may further perform pretreatment of identified ROIs. Predicted image segmentation regions may be pretreated before further processing. The pretreatment of a single region can include a point operation, a logical operation, an algebra operation, erosion, dilation, and/or smoothing. Regions can also be filtered, merged, and/or simplified.

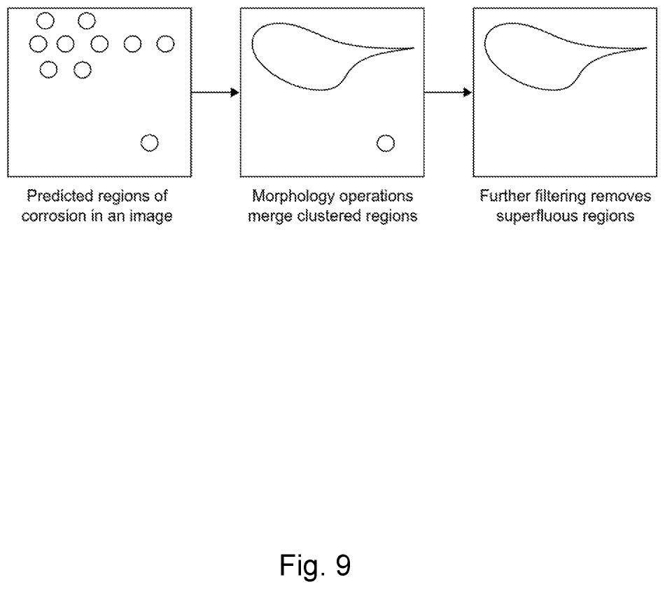

In some examples, a neural network predicts areas of corrosion by performing image segmentation on a series of images. As illustrated in FIG. 9, in order to merge clusters of small area predictions, a sequence of dilation and erosion morphology operations are applied. Furthermore, to reduce the amount of superfluous predictions, regions with an area having fewer than 100 pixels are removed.

In some examples, a spherical image is captured via data capture process 320. The spherical image has a geometric transform applied to it, turning it from a spherical image into undistorted “flat” images. Images are subsequently normalised and resized. By image processing module 330, the flat images are then input into an image segmentation neural network, which predicts the severity/type/class of corrosion for each pixel/region in the images. The neural network is “trained” by studying sufficient images of example ROIs, and regions of non-interest. This is an iterative process. The predicted ROI are then filtered/cleaned/simplified, and stored/delivered after being processed by a 3D association module (described below). Small area/skinny ROIs are filtered out, and/or neighbouring ROIs are joined together. Proposed ROI edges are smoothed and/or simplified.

Referring again to FIG. 3, system 300 may further include a 3D association module 340. 3D association module 340 may be configured to convert the 2D analytics results produced in the image processing module 330 (in pixel space) to a 3D representation (in physical space), and associate the output of image processing module 330 with spatial and unit metadata from the inspection site. The output of module 340 may be a location and information-aware representation of all findings in the image processing module 330.

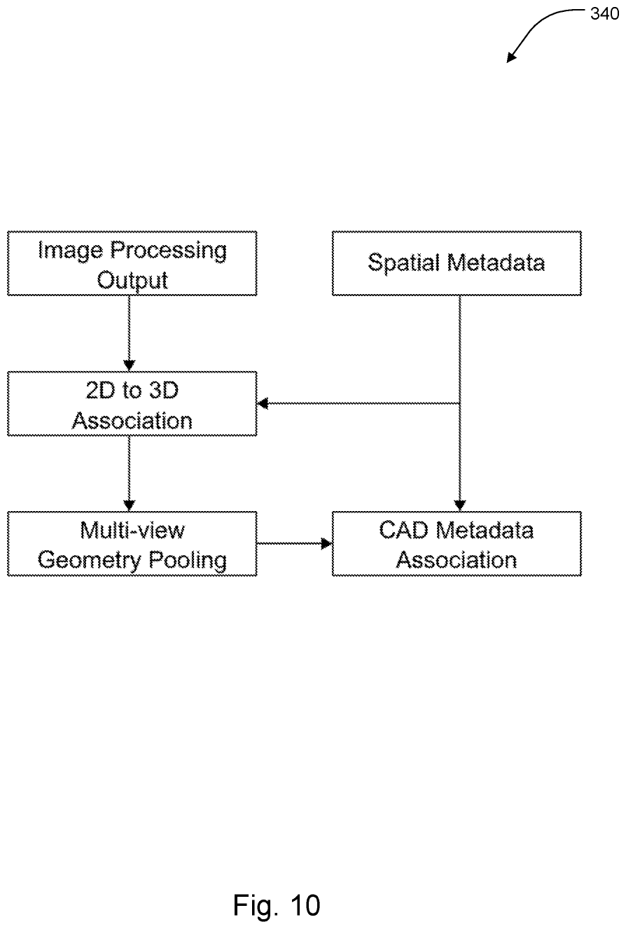

Referring to FIG. 10, there is illustrated an example flowchart showing the operation of 3D association module 340. Output from image processing module 330 reflects the analytics on individual images. The 2D image data is then mapped to associated 3D information given by the geometry metadata provided during data capture. All processing results are thus associated with 3D information, converting from pixel space to real-world metric space. The multi-view geometry pooling modules fuses information from different images with overlapping or non-overlapping regions. The output from this module is an asset health at all scanned surfaces as represented in 3D space. In one example, the image processing module 330 may output may be a degree of rusting or identification of a region of interests, such as a location of coating degradation or corrosion. The areas where data has not been captured, due to obstruction, insufficient coverage or any other reason are quantified and reported. CAD metadata containing equipment IDs are then associated with each feature region. The output is a spatially and information-rich representation of all output from the Image processing module.

Metadata for each scene component may include, but is not limited to, 3D spatial map of detected corrosion, 3D spatial map of areas where image data has not been captured, number and type of corrosion detected, uncertainty in corrosion detection, assessment of scene component health, assessment of recommended scene component intervention, and key measurements including certain point to point distances, surface areas and volumes.

The image processing 330 output is represented in the image pixel space, as a combination of (i, j) pair values. Associated with these values is metadata information regarding the output from the image processing module 330 as described above. Each image is also coupled with spatial metadata, including the intrinsic and extrinsic properties of the image. Furthermore, additional 3D information such as a point cloud representation is injected in the same reference frame. This metadata is presented as part of the data capture process 320. Using a pin-hole camera model, raytracing is conducted on the images to conduct 2D to 3D association. In some examples, for each (i, j) pair under consideration, a 3D representation is evaluated, either as a depth map, or in Cartesian/polar coordinates, e.g. as (x, y, z). The process is repeated exhaustively across the output of the image processing output, resulting in a 3D tagged database of key analytics results from the image processing module 330.

Since data is captured densely, there is often significant overlap on the scene between adjacent images. This results in a 3D surface being observed multiple times from different view-points. Such overlapping observations are then aggregated using an aggregation function such as mean, max or mode pooling functions. The output is then a 3D observation model of the observed areas. Lastly, the output from the multi-view geometry pooling module is fused with a CAD model presented during data capture 320. Given that both the 3D reconstruction data and the CAD model are available in the same reference frame, data points relating to each equipment in the CAD model can be queried, returning the analytics output for the corresponding surfaces. An aggregation step can then be applied to evaluate health metrics for each equipment tag. Aggregation algorithms can be tuned to particular equipment/asset components, such as sum, max, standard deviation, distribution and density pooling. In some examples, the outputs from the 3D association module 340 include (i) each unique ID in the CAD model being associated with image points and the analytics output, and (ii) each image point being associated with a particular surface on the CAD model.

In some examples, when processing data from an offshore platform, the output of image processing module 330 can be represented as pixel-wise segmentation masks over images. Each pixel is therefore tagged with information such as the level of corrosion it has, and additional data such as the certainty of that prediction. Spatial data information from the data capture module 320 is coupled with each image, for example, as a point cloud representation of the scene, and as extrinsic and intrinsic information of the camera setup. For example, associated with each spherical image, there exists its Cartesian location in (x, y, z) and its orientation as roll, pitch, and yaw. By applying a pin-hole image model, each pixel in the image can be projected from the sensor frame to a real-world as a line-ray. This array can be intersected with the point cloud information to convert that pixel into (x, y, z) co-ordinates.

With each pixel denoted in Cartesian co-ordinates, all images can be brought into the same global reference frame. Scene context from multiple images can then be aligned together, with error bounds relating to the uncertainty in the extrinsic and intrinsic information of the imaging system. The information can then be pooled together spatially (as discussed below), or it can be associated with individual equipment tags. Association to equipment tags can be conducted through different pooling techniques, for example, mean pooling calculated mean statistics of analytics on a given equipment tag. More details on collating statistics and metrics is discussed in the operational database module.

Referring again to FIG. 3, system 300 may further include an operational database module 350. Operational database module 350 may be configured to take as input, spatially referenced analytics results, and returns a fault/feature database that is spatially, temporally, or geometrically aggregated. In some examples, operational database module 350 is employed in a production facility to produce a fault database which can be correlated with priority metrics to build a prioritisation table. This prioritisation table can enable risk-based management of assets.

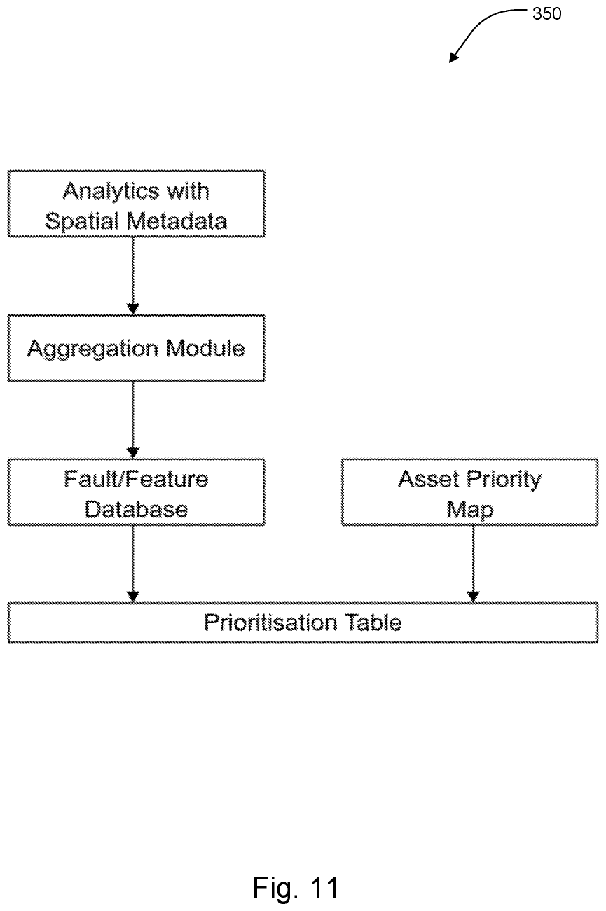

Referring to FIG. 11, there is illustrated an example flowchart showing the operation of operational database module 350. Spatially tagged analytics may be aggregated together to build a fault/feature database. These can then be matched with the priority order of discretized units in the production facility to build a prioritisation table.

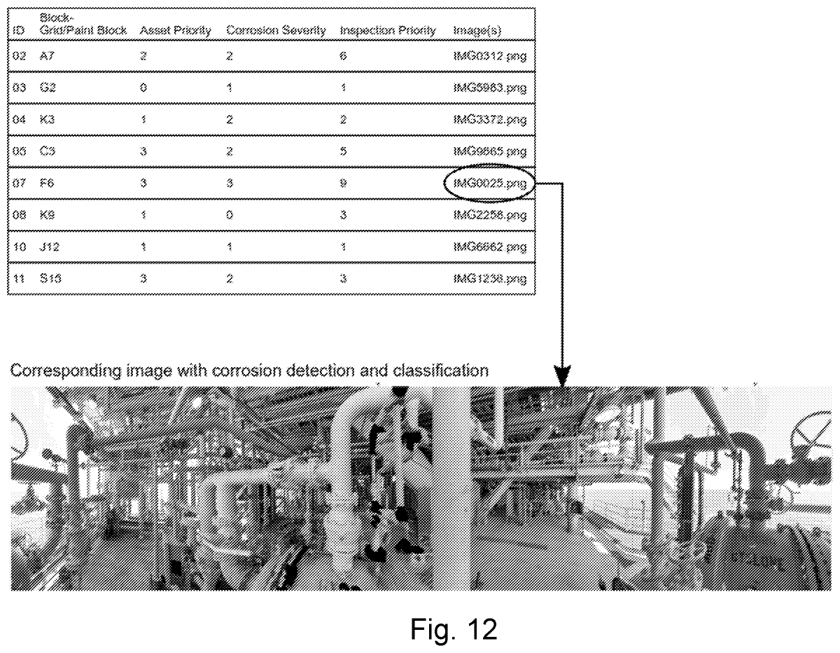

In some examples, spatial analytics on an offshore platform can be represented as 3D point cloud information, whereby each pixel from each image has been tagged with an (x, y, z) point, has been associated to a 3D CAD model tag, and has also been associated with corrosion statistics such as severity and uncertainty. This information can then be pooled using a variety of different metrics depending on the operational needs. For example, painting is scheduled per grid block in an offshore platform, with each deck containing many grids. To pool the information, the spatial data can be voxelized using a max-pool framework to preserve the worst corrosion severity per voxel. A voxel is a unit cube in 3D space analogous to a pixel in 2D space. Voxels represent a sampled 3D space, spanning the space in (x, y, z) coordinates. The Voxel output can then be sum-pooled across a grid, to demonstrate the total surface area coverage of corrosion in that grid block. Such a database can be represented as a table or a heat map, as shown in FIG. 12, which illustrates the concept of spatial aggregation for corrosion database construction. The top right image shows spatial aggregation per image as a spatial heat-map, and the top left shows the spatial aggregation as a table. Each element of the database may also be linked to an “inspection priority” metric, as provided by the asset SME, which allows for higher priority units to be addressed first if there is an onset of corrosion there.

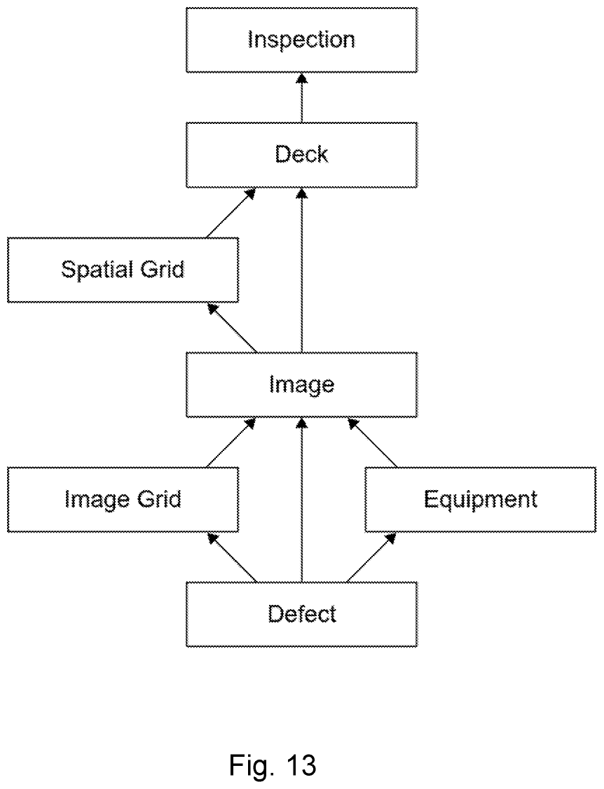

Referring to FIG. 13, there is illustrated an example hierarchy of aggregations within the corrosion database, where Inspection contains Deck contains Images as well as Spatial Grid aggregations of images. Images contains Image Grid aggregations of Defects as well as Equipment.

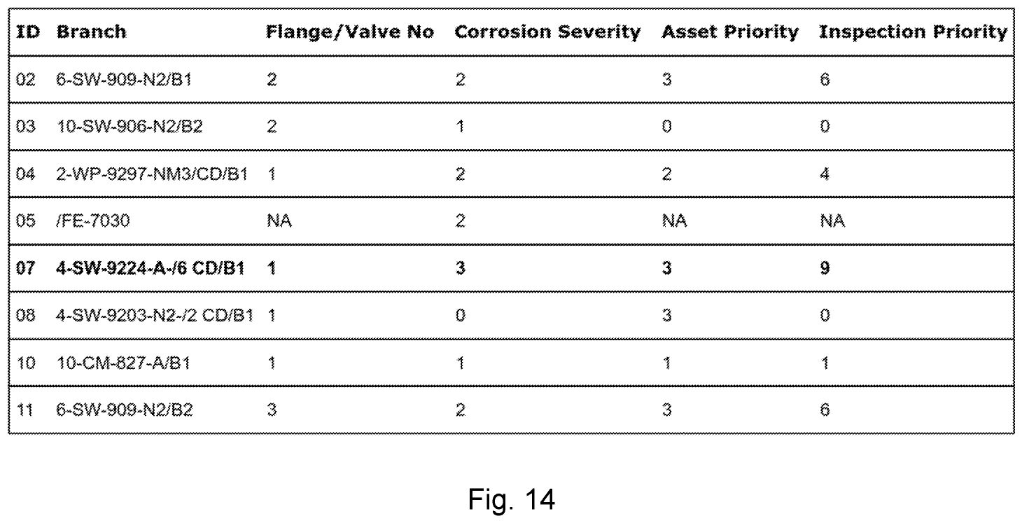

To build an equipment-based prioritisation table, corrosion statistics can be aggregated per equipment tag in the CAD model. This may involve initial voxelization, followed by aggregation by equipment ID. Additional statistics such as spread, area coverage, density may be evaluated per equipment tag. FIG. 14 shows a follow up prioritisation table when considering components such as flanges in an offshore platform.

Referring again to FIG. 3, system 300 may further include a visualisation module 360.

The collection of image analytics and corrosion database is delivered to a user via visualisation module 360, which is configured to enable QA processes (described below), and to deliver risk and priority data.

The visualisation, or image analytics, module 360 may provide a detailed interactive visualisation of captured imagery. Visualisation and interaction pertains to the data fusion of captured imagery, individual fault statistics, equipment information and 3D spatial information.

The interactions with each image location include, but are not limited to: the sharing of information pertaining to specific faults or items of equipment (the information shared will have the necessary information to retrieve the relevant visualisation of the fault); provision of multi-perspective image data, via linkage from equipment or fault locations, through associated queries on the relevant image subsets from all available captured imagery, including historical imagery, 3D points and its associated data; quality control of the provided data, allowing for the commenting, addition, deletion and modification of fault information where the feedback is incorporated into updated statistics, as well as continuous improvement of the data processing pipeline.

The spatial information is additionally utilized to provide immersive navigation between images, coupled with a contextual map indicating height location within the platform as well as the local plan view location within the deck.

In some examples, the linkage information stored as a queue of tasks can be revisited in planning sessions or during operations to provide accurate and timely communication of information.

The equipment-based prioritisation table, as previously described, may be presented as an interactive table that can be aggregated at multiple levels, the dataset may also be presented as interactive spatial heatmaps.

Dataset queries may be designed to cater for specific operational objectives where queries can fuse multiple sources of data, including but not limited to: equipment type, equipment risk, substrate type, surface corrosion extent, spatial information including accessibility due to height.

An example query designed for painting operations may be defined such that areas are subdivided into smaller regions where the light corrosion is aggregated to provide the most suitable areas for the next paint operation, the query may be extended to take into account access height, to provide prioritisation of painting with and without specialised staff and/or equipment for working at height. When planning critical maintenance operations all high risk items, for example high pressure pipes, locations of any high severity corrosion will be flagged for high priority mitigation response.

System 300 may further include a quality assurance (QA) module 370.

The QA module 370 is configured to identify areas/tasks in which system 300 performs in a suboptimal manner, and to adjust existing processes such that system 300 improves its performance on tasks. This process may be continual over the lifetime of system 300.

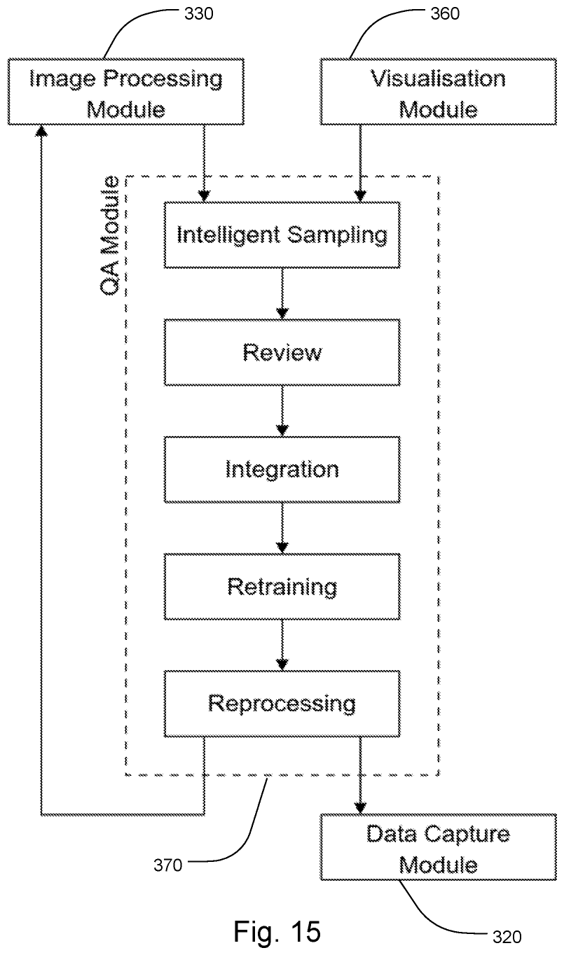

Referring to FIG. 15, there is illustrated an example flowchart showing the operation of QA module 370.

Scene understanding techniques in the image processing module 330 may be continually updated throughout the operation and lifetime of system 300. ROIs may be assessed by their performance on the original tasks or derivative tasks. For example, predicted “defect” class ROIs may be selected by their ability to predict regions of “cracking” class. ROIs may be selected if their predictions are incorrect, or they may be identified by a low “confidence factor”. Areas of suboptimal ROI performance can be intelligently identified with uncertainty sampling techniques (such as selecting ROIs with high entropy, collecting samples near neural network decision boundaries, least confidence strategies, or some other computed confidence factor, etc.), through automated feature sampling techniques (such as selecting ROIs that lie well outside the cluster of information a neural network has been trained upon), and may also be identified by interaction and feedback from stakeholders of system 300 (e.g. operators, client management, internal staff, etc.).

In some examples, a neural network is used to predict substrate condition on images. ROIs corresponding to areas of high entropy (i.e. low confidence) may be identified and extracted for subsequent review.

In some examples, for an intelligently sampled ROI instance the associated features for the predicted class are reviewed/changed by an annotator/SME. Reviewed ROIs are integrated into existing processes so that the class definition of the new associated feature provides a higher confidence factor for accurate identification of similar instances. This may include retraining an image segmentation network using the updated database, or further training a derivative image segmentation network to perform a different task.

In some examples, ROIs are reviewed manually, or by some other process. ROIs may be stored for later integration into existing processes. For example, results of the data-review may be added to an abundant database of ROIs used in neural network training and/or validation. New and/or derivative neural networks (i.e. those that perform other tasks related to fabric maintenance) may be trained using the updated database. In some examples, continual updating of a database of the abundant images occurs, where SMEs are asked to provide continual feedback to select ROIs.

In some examples, there is provided a method of active learning. The method comprises a first step, wherein a confidence factor for each pixel in an input image is computed for the output from an image segmentation neural network. A confidence factor may comprise one or more sampling metrics, such as an “uncertainty factor” indicating a likelihood that a region identified by the image segmentation process lies near a decision boundary (as calculated using probability or entropy), a “novelty factor” indicating the region identified by the segmentation process lies “far” away from previously observed data, and a “randomness factor” indicating random exploratory regions extracted from the unlabelled pool of data to encourage data exploration and avoid overfitting to a prior segmentation model. Regions with a low confidence factor are extracted. The method further comprises a step wherein these regions are manually reviewed by a subject matter expert who annotates the regions. The method further comprises a step wherein the reviewed regions are integrated into the existing database of annotated regions. The method further comprises a step wherein an image segmentation neural network is trained using the updated and labelled region database. The method may then be repeated in order to provide for continuous active learning.

In some examples, there is provided a method for transferring learning. The method comprises a first step wherein regions containing nuts and/or bolts are extracted in response to a client wishing to detect corrosion on nuts and bolts, which has a different corrosion class definition. The method further comprises a step wherein the extracted regions are manually reviewed by a subject matter expert who annotates the regions with the appropriate class definition. The method further comprises a step of integrating the reviewed regions into an existing database of annotated regions. The method further comprises a step of training an image segmentation neural network using the updated and labelled region database. The method may then be repeated in order to provide continuous transfer of learning.

In some examples, there is a balance between operational performance and image segmentation evaluation metrics. A conventional method of measuring the performance of image segmentation methods is to compute the mean intersection-over-union (mIOU) for proposed regions (also known as the Jaccard index). Additionally, the hyperparameters (such as thresholds and class-weighting) used for various tasks are tailored to specific tasks. For instance, operationally, it may be critical to detect a heavily damaged substrate and therefore more significant emphasis is placed on any errors there, whereas, conventionally, no weighting would be applied to a specific class.

The detection rate criteria refers to the rate at which processes executed by system 300 correctly draw attention to ROIs. For example, if a large region contains a defect and system 300 correctly identifies a portion of this region, the prediction is considered successful since operator attention is driven towards the problem area. Detection rates (i.e. recall) are calculated on a per-instance basis. Orthogonally, miss-fire rates (precision) would be the rate that predicted ROIs are true ROIs.

In some examples, a detection rate is defined as:

$$Detection success D = \{ \begin{matrix}1 , \vert A ⋂ B \vert \geq threshold \\ 0 , \vert A ⋂ B \vert < threshold\end{matrix}$$

where A is the ROI prediction and B is the true ROI (i.e. an ROI where a defect exists).

$$Detection rate \overline{D} = \frac{1}{N} {\sum }_{n = 1}^{N} {D}_{n}$$

where N is the true number of ROIs.

$$Misfire rate \overline{R} = \frac{1}{M} {\sum }_{m = 1}^{M} {D}_{n}$$

where M is the number of ROIs predicted by system 300.

In contrast to detection/miss-fire rates, coverage rates may be calculated on the overlap of predicted and true ROI area. Coverage rate per ROI is given by C=|A ∩B|. For example, if a predicted ROI overlaps a true ROI by 50%, then the coverage rate is 50%.

The different components and processes mentioned above can be substituted and tweaked depending on the application at hand. These include:
Support for different data collection modalities. The same processing framework can be applied to thermal or hyperspectral data, or on video data, which can be considered a sequence of images.
The core principles of this process can be applied to different applications beyond the offshore corrosion mapping mentioned above. For example, it can be extended to onshore production facilities to do fault mapping, or into the construction market vertical to monitor the health of a construction site.
The image processing algorithms that drive the analytics mentioned here are subject to change. For example, variants of a deep neural network may be used to drive the image segmentation process. However, this module is highly configurable and is able to utilise other machine learning or artificial intelligence architectures as needed.
The visualisation module 360 is optional and may be replaced with direct data delivery for integration for third-party consumption.

The processes described above are generally automated and are therefore flexible to be deployed in real-time (by reducing the extent of the QA process). When deployed onto a platform (automated or hand-held) at a production facility, analytics can be conducted quickly. This can enable actively guiding the data collection workflow to focus on areas of interest. For example, the software may request extra data to be collected in regions that look corroded or confusing. Or it will guide data collection in areas that are otherwise occluded or hidden to the cameras. Lastly, it can direct data collection areas that were previously prone to corrosion degradation by comparing against a previously collected database.

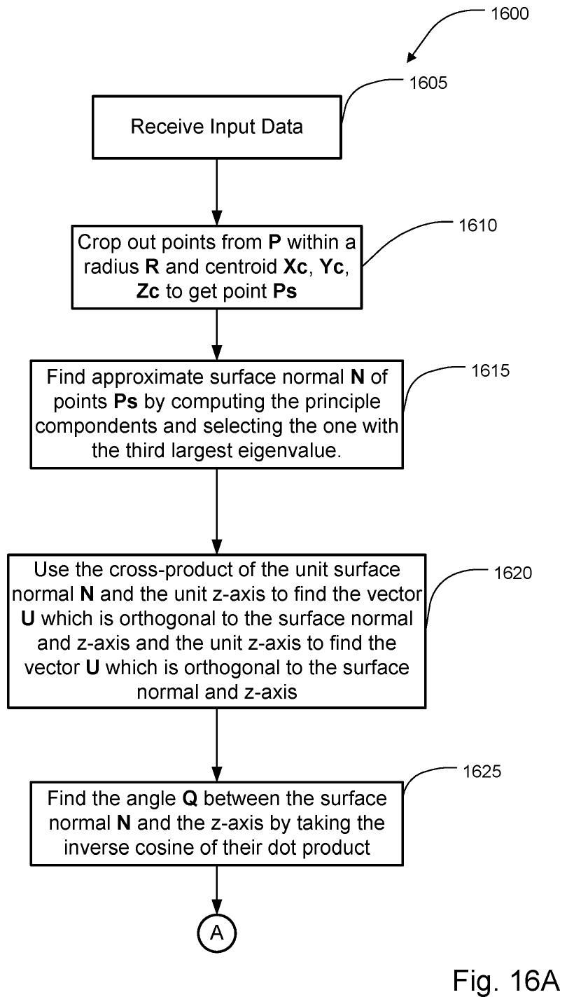

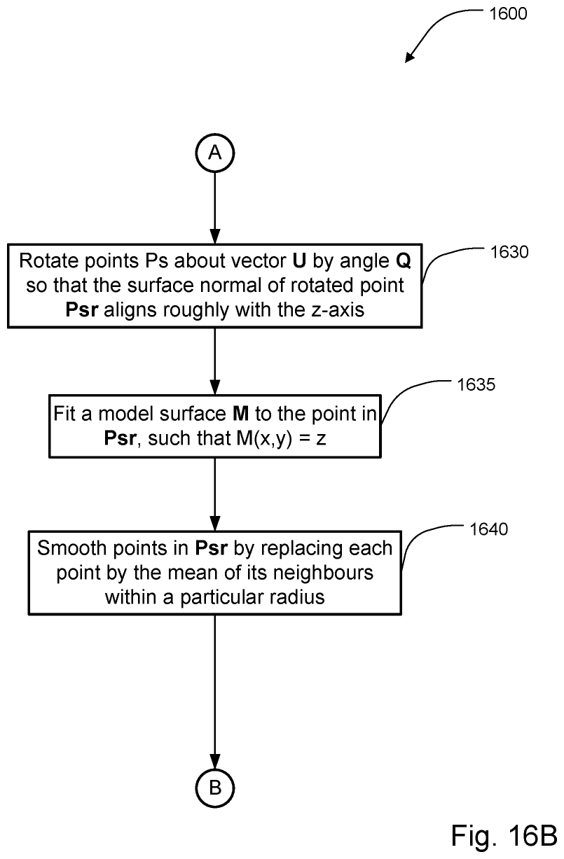

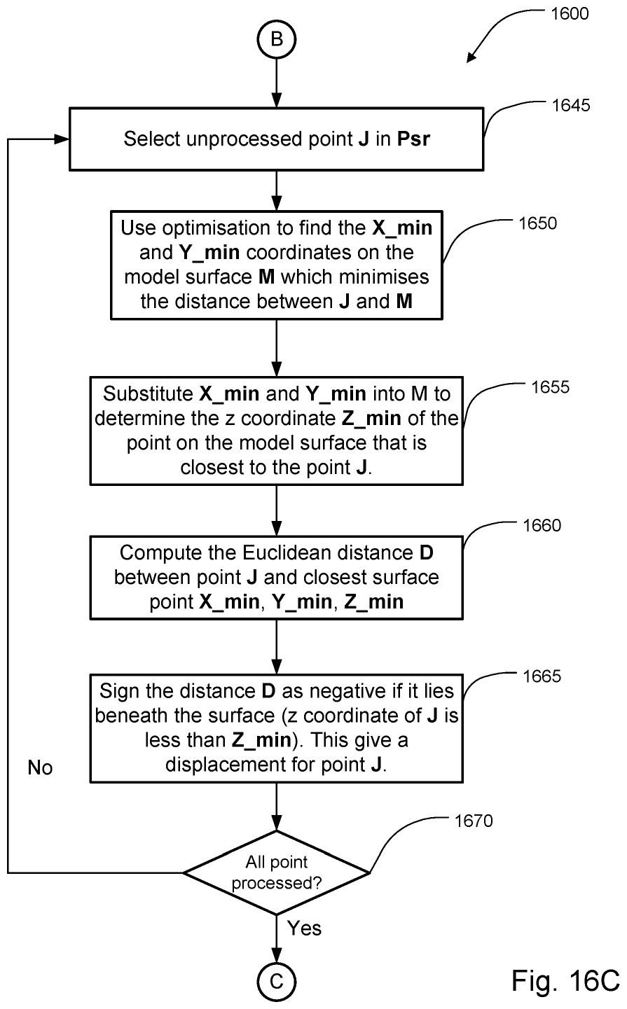

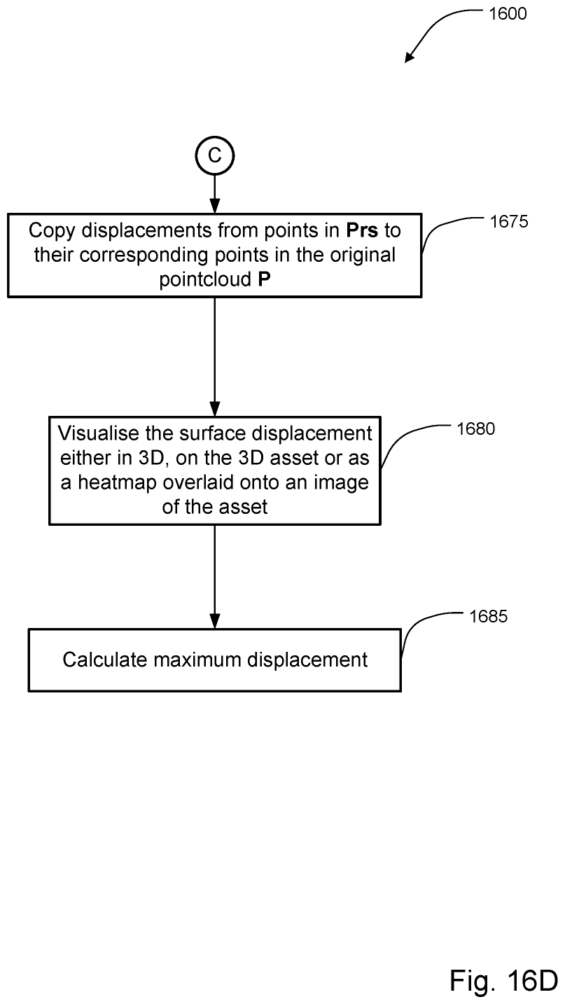

A method of surface deformation detection 1600 will now be described in relation to FIG. 16. The method of surface deformation detection 1600 may be may be practiced on a computer such as the processing system 200 and communicate over a network to other processing systems as required. The method of surface deformation detection 1600 receives point cloud information for a production asset and analyses the 3D point cloud information to determine regions of the production asset where there are localised regions that are raised or pitted to determine regions for further visual inspection. The localised regions may be planar or non-planar. The method 1600 may receive data from the system 300 and may take as input images, such as two or more images, and 3D point cloud information generated by the system 300 at data capture process 320, locations of regions of interest or degree of rusting from image processing module 330 and 3D point cloud information and mapping between the 2D images and 3D point cloud from the 3D association module 340, as described above. The point cloud information and data from the images are combined to produce information about a state of the equipment.

The method of surface deformation detection 1600 starts with a receive input data step 1605 where three sets of input data may be received by the processing system 200. A first of the input data is 3D point cloud data. Each point in the 3D point cloud will have an X. Y, and Z coordinate along with other attributes for each of point of the point cloud data. A production asset may be comprehensively surveyed using cameras and 3D image capture equipment. The cameras and 3D image capture equipment may be used to capture flat and/or panoramic images, 3D point-clouds, spatial metadata as well as localisation information for all data points (i.e., the inspection data). The generation of 3D point cloud information may be carried out according to the image processing module 330.

A second input is a surface deformation location being an X, Y and Z coordinate (Xc, Yc, Zc). The surface deformation location may be a known region of interest of the production asset from earlier inspections or may be a location about which the method of surface deformation detection 1600 may be performed to determine if there is any deformation of the surface. The surface deformation location may be a point on the production asset from which the point cloud was determined. The location may be obtained by a user selecting a single point in space where the surface deformation is located, such as an already known location. Alternatively automated methods may be used to locate surface deformations in the 3D point cloud or image data captured by the camera. In one embodiment, the location may be determine in a 2D RGB image from a camera using an image detection algorithm. Alternatively, a gradient may be determined between each point with respect to neighbouring points. The gradient may then be used to select the location of a surface deformation. Alternatively, a machine learning algorithm may be trained and applied to the point cloud data to determine the location of the surface deformation. The location may be supplied as a set of coordinates in the same coordinate space as the input 3D point-cloud data. Ideally the surface deformation location is a centre of a target surface deformation.

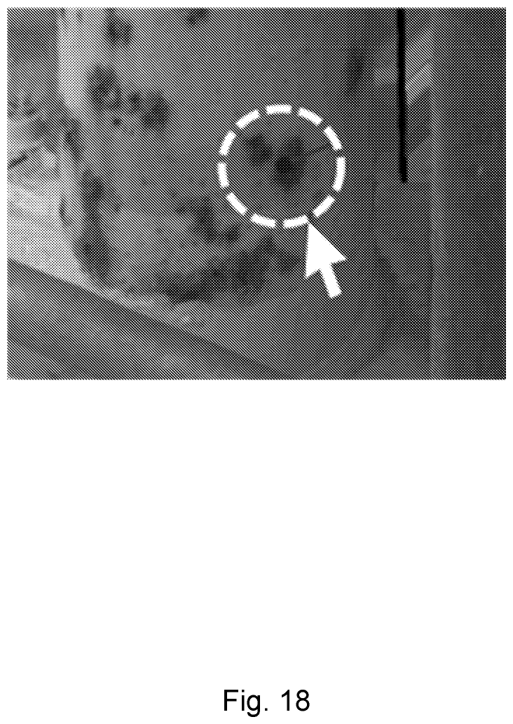

The third input is a selection radius (R) which is used during the processing of the method of surface deformation detection 1600 to limit the points of the 3D point cloud that will be processed. An example of a selection radius is given in FIG. 18. The selection radius may extend beyond the perimeter of the surface deformation. The selection radius may be input manually by the user or determined via an automated approach. In one example, the radius may extend from the surface deformation location (Xc, Yc, Zc) to either a predetermined upper limit for the radius or be set according to a profile of the surface. When the radius is set according to the profile the radius may be limited by a large structural change of the surface, such as a corner. The large structural changes may be detected by looking at principle components of for a region of the point cloud, determined using Principle Component Analysis (PCA). Typically the selection radius is for a sphere, but may operate as similar to a circle when the points are planar.

Next, a crop points step 1610 processes the 3D point cloud to remove points in the point cloud that are outside the selection radius. That is, the 3D point cloud is filtered to select point within a predetermined distance of the selection radius. The result is a subset of the point cloud, Ps, located within the selection radius and centred on the surface deformation location. At a find normal step 1615 an approximate surface normal to the points Ps, determined in the crop points step 1610, is determined. The surface normal of the point cloud may be approximated by a principle component. Principal Component Analysis (PCA) is used to find three principle components, and the component with the third largest eigenvalue is taken as the approximation of the surface normal.

Once the surface normal is determined, a find orthogonal vector step 1620 is executed by the processing system 200. The find orthogonal vector step 1620 uses a cross-product of the unit surface normal, determined in the find normal step 1615, and the unit z-axis to find a vector, U, that is orthogonal to a plane made by the surface normal and the z-axis. The point-cloud is rotated such that the approximate surface normal N aligns roughly with the z-axis. To do this, the axis of rotation, and angle by which to rotate, is found. The axis of rotation is a vector that is perpendicular to both the surface normal and z-axis. The unit vector of the three-dimensional surface normal N is:

$$\hat{N} = \frac{N}{\vert N \vert}$$

The unit vector of the z-axis is:

$$\hat{z} = \{ 0 , 0 , 1 \} .$$

The cross-product of the unit vector of the surface normal and the unit vector of the z-axis is:

$$U = \hat{N} \times \hat{z}$$

Where U is a three-dimensional axis of rotation.

At a find angle step 1625 an angle, Q, is determined between the surface normal and the z-axis. The angle Q may be found by taking an inverse cosine of the dot product of the surface normal N and the unit z-axis. The angle between the two unit vectors may be found by taking the inverse cosine of their dot product:

$$Q = {cos}^{- 1} ( \hat{N} \cdot \hat{z} )$$

Q is the angle by which to rotate the point-cloud about U.

Next, at an align surface normal step 1630 the subset of points of the point cloud, points Ps, are rotated about the vector, U, determined in the find normal step 1615. The points Ps are rotated by the angle Q determined in the find angle step 1625. The result is the surface normal of the rotated point, Psr, aligns approximately with the z-axis. A rotation matrix R is defined as:

$$R = [ \begin{matrix}cos θ + {u}_{x}^{2} ( 1 - cos θ ) & {u}_{x} {u}_{y} ( 1 - cos θ ) - {u}_{z} sin θ & {u}_{x} {u}_{z} ( 1 - cos θ ) + {u}_{y} sin θ \\ {u}_{y} {u}_{x} ( 1 - cos θ ) + {u}_{z} sin θ & cos θ + {u}_{y}^{2} ( 1 - cos θ ) & {u}_{y} {u}_{z} ( 1 - cos θ ) - {u}_{x} sin θ \\ {u}_{z} {u}_{x} ( 1 - cos θ ) - {u}_{y} sin θ & {u}_{z} {u}_{y} ( 1 - cos θ ) + {u}_{x} sin θ & cos θ + {u}_{z}^{2} ( 1 - cos θ )\end{matrix} ]$$

Where θ is the angle Q, and uₓ,u_{y},u_{z} represent the x, y and z components of the rotation vector U. The dot product between the point-cloud Ps and the rotation matrix may be determined to rotate the point cloud Ps:

$${P}_{sr} = R \cdot {P}_{s}$$

The rotated point cloud is now aligned with the z-axis. The align surface normal step 1630 is carried out to simplify further steps in the method of surface deformation detection 1600.

At a fit model surface step 1635 a least-squares algorithm may be used to fit a model surface, M, to the rotated points, Psr, that were determined in the align surface normal step 1630. The model surface is defined as M(x,y)=z. The model surface may be considered an estimate of a deformation free representation of a surface on which the points lie. One example of a model surface is a parameterised polynomial model. In one example a model comprising a junction of two surfaces may be used where the model is a piecewise polynomial model. In another example a rigid shape defined by a set of parameters may be used to model a complex surface such as a valve handle. In one embodiment, the model used for the model surface may be selected from two or more models such as the parameterised polynomial model, the piecewise polynomial model and the rigid shape defined by a set of parameters.

The model surface is fitted by an optimisation algorithm, such as the least-squares algorithm, orthogonal distance regression (i.e. total least squares) or parametric methods. When a model is selected from two or more models the results from the optimisation algorithm may be used to compare and select the model best fit as the model that is the most optimised. A suitable optimisation algorithm may be able to regress the parameters of a model from observation data. For the parameterised polynomial model surface the optimisation algorithm learns the parameters of a model to regress the z coordinate of a point in the point-cloud from its x and y coordinates. All points in the point-cloud may be used to fit the model. As such, the point-cloud used to fit the model includes points representing a surface deformation in the point cloud. In doing so, a matrix M is calculated which has parameters for the estimated model surface. In the example of a kth order polynomial model surface, the z coordinate is given by:

$$z = {M}_{00} {x}^{0} {y}^{0} + {M}_{01} {x}^{0} {y}^{1} + {M}_{10} {x}^{1} {y}^{0} + … + {M}_{kk} {x}^{k} {y}^{k}$$

$$z = f ( M , x , y )$$

The steps from the crop points step 1610 to the fit surface model step 1635 described how a model surface may be fit to the material surface of the production asset at, or near, the location of the surface deformation, represented by the point cloud Ps. If a suitably large area of the measured physical surface is used for fitting, then the surface deformation may have a minimal impact on the fitted model. The result is the fitted model resembles the shape of the un-deformed material surface. However, if too large an area is selected then the model surface may not be fitted, while too small an area will be affected by surface deformations. Selection of a suitably model surface, with generic complexity, allows fitting of complex surface shapes such as curved surface. As a result, the point cloud of production asset 1700 may be applied to complex surfaces.

Next, at the smooth points step 1640, the points in the subset of points Psr are smoothed to remove noise. One technique for smoothing the points is to replace each point in the subset of points with a mean of the neighbouring points, that is, by using locations of neighbouring points in the point cloud. The neighbouring points may be selected based on a radius centred at the current point. An example of such a radius is 5 mm when the selection radius (R) is 60 mm. Alternatively, a set number of nearby points may be selected. In one example, the nearest five points may be selected. The smooth points step 1640 is optional.

A select unprocessed point step 1645 marks the start of a loop where each point in the subset of points Psr are processed by a find (x,y) of closest point on model surface step 1650, a find (z) of closest point on model surface step 1655, a determine distance step 1660 and a determine sign step 1665. A point J is selected at the select unprocessed point step 1645. At the find (x,y) of closest point on model surface step 1650 the X_min and Y_min coordinates on the model surface M are located where a distance between the current point and the model surface M is minimised. The closest point may be determined by iteratively minimising the following expression for x and y:

$${( {J}_{x} - x )}^{2} + {( {J}_{y} - y )}^{2} + {( {J}_{z} - f ( x , y , M ) )}^{2}$$

Such that the equation below is solved:

$${x}_{min} , {y}_{min} := min x , y {( {J}_{x} - x )}^{2} + {( {J}_{y} - y )}^{2} + {( {J}_{z} - f ( x , y , M ) )}^{2}$$

Where J is the current point.

At the find (z) of closest point on model surface step 1655 the Z_min coordinate is found by substituting the X_min and the Y_min coordinates into the surface mode M to determine the Z coordinate. Substitute the x and y values which minimise the above expression into the equation for the estimated model surface:

$${z}_{min} = f ( M , {x}_{min} , {y}_{min} )$$

gives the x,y and z coordinates of the closest point on the estimated model surface to the point J.

At a determine distance step 1660 a Euclidean distance, D, is determined between the current point of the subset of points and the closes point of the model surface M, defined by the X_min, Y_min and Z_min determined in the find (x,y) of closest point on model surface step 1650 and the find (z) of closest point on model surface step 1655. In one example, the distance between the current point and the model surface is measured normal to the model surface, which represent a surface of the production asset on which the points were measured. The distance between the estimated model surface and the point J is computed as the Euclidean distance between the closest point on the surface (given by xₘᵢₙ, yₘᵢₙ, zₘᵢₙ) and the point J:

$$D = \sqrt{{( {J}_{x} - {x}_{min} )}^{2} + {( {J}_{y} - {y}_{min} )}^{2} + {( {J}_{z} - {z}_{min} )}^{2}} \qquad ( 1 )$$

In one embodiment of the method of surface deformation detection 1600 an optional compensation step is included to compensate for biases in the model surface caused by large deviations, such as larger blisters or pits, impacting the estimation of the un-deformed surface. A linear transformation is applied to each distance calculated using equation (1) above to compensate for large deviations in the point cloud according to:

$${D}_{corrected} = ( D * a ) + b$$

Where D_{corrected} is the corrected distance and D is the output of equation 1, sometimes referred to as an initial distance. The constants a and b are determined in a calibration phase, before execution of the method of surface deformation detection 1600 using a calibration dataset of scanned blisters and pits with manually measured heights. Linear regression is used to model the manually measured heights as a linear function (with parameters a and b) of the predicted heights for the calibration dataset. Once calibrated offline, the parameters a and b are used in the method of surface deformation detection 1600. The compensation function outlined is independent of a position of the point being corrected in the point cloud as the values of a and b are constant and do not vary with any changes to the x, y or z coordinate of the point.

The compensation function may be applied because the model surface is determined including points of the surface deformation in the point cloud. As described, the compensation function is applied to the distance value, however the compensation may be applied in other ways. In one embodiment, the compensation equation is included in the determination of the distance in equation 1. In another alternative, the location of the points in the point cloud may be modified to compensate for biases in the model surface caused by large deviations. Alternatively, the surface model may be modified to compensate for biases in the model surface caused by large deviations.

The last step of the loop is the determine sign step 1665 where a sign of the Z_min is determined. The sign indicates if the current point is located above or below the model surface M. The distance is signed as negative if J_{z}<zₘᵢₙ. Therefore, all points in the point cloud below the estimated model surface are signed negative, and all points above the estimated model surface are signed positive. The sig may be used in estimating a cause of surface deformation. For example, a positive deformation may indicate paint expansion due to light corrosion while a negative deformation may indicate severe corrosion.

At a check points step 1670 a check is made to determine if all points in the subset of points has been processed in the loop. If there are still points to process then the method of surface deformation detection 1600 returns to the select unprocessed point step 1645. Otherwise, the method of surface deformation detection 1600 proceeds to a copy distance to the original points step 1675 where the distance D from the determine distance step 1660 along with the sign of the distance D determined in the determine sign step 1665 are mapped back to the corresponding points in the unmodified point cloud P. That is, the point cloud received in the receive input data step 1605 before modification in later steps of the method of surface deformation detection 1600. The copy distance to original points step 1675 is an optional step.

These displacements show a deviation of the deformed surface, captured by the point-cloud, from the un-deformed, true material surface that has been approximated by the estimated model surface. The surface displacement, or deterioration, may be shown for each point in the point cloud, showing the spatial distribution/profile of the amount of deterioration.

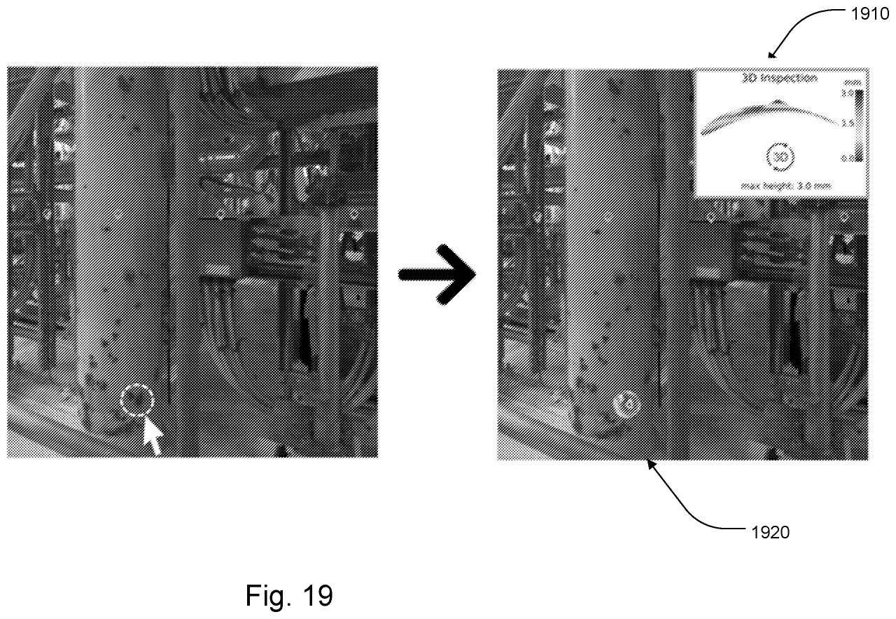

At a generate visualisation step 1680 a visualisation may be prepared for an inspector. In one example of the generate visualisation step 1680 the points of the point cloud belonging to the surface of the object may be coloured by the displacements calculated at the determine distance step 1660 to indicate where the material surface deviates due to surface deformation. As the information is for a 3D point cloud, the colour point cloud information may be viewed in 3D from different angles. The coloured points of the point cloud may be overlaid onto a 2D image to providing a heatmap of the spatial distribution of the amount of deterioration due to the deformation. An example output may be seen in FIG. 19 where a 3D inspection window 1910 is displayed showing an enlarged and rotatable view of a point cloud of a section of pipe 1920.

At a calculate maximum displacement step 1685 a maximum displacement, or distance, may be estimated by finding a maximum of the displacements calculated for all points J at the determine distance step 1660. The maximum displacement may be a total displacement positive or negative, a positive displacement only or a negative displacement only. The maximum displacement may be output or reported as a statistic for the given asset within an asset management system or reported alongside a visualisation of displacements as in FIG. 19. In one example, the maximum displacement may be stored in the operational database module 350 of the system 300. In one example, the maximum displacement is calculated and may be used to classify the point cloud, or a region of the point cloud. Points belonging to the production asset on which the maximum displacement is measured may be classified based on the maximum displacement and displayed to a user with a colour, shape and/or size of each point set according to the maximum displacement. In one example, all points in the point cloud of the asset will have a colour set according to the maximum displacement. This may allow a user of the system to more easily see a worst case displacement for the production asset by displaying all points with the same information. Alternatively, the maximum displacement may be displayed without the use of a point cloud, for example, by colouring a representation of the production asset or displaying and linking the value of the maximum displacement with the production asset.

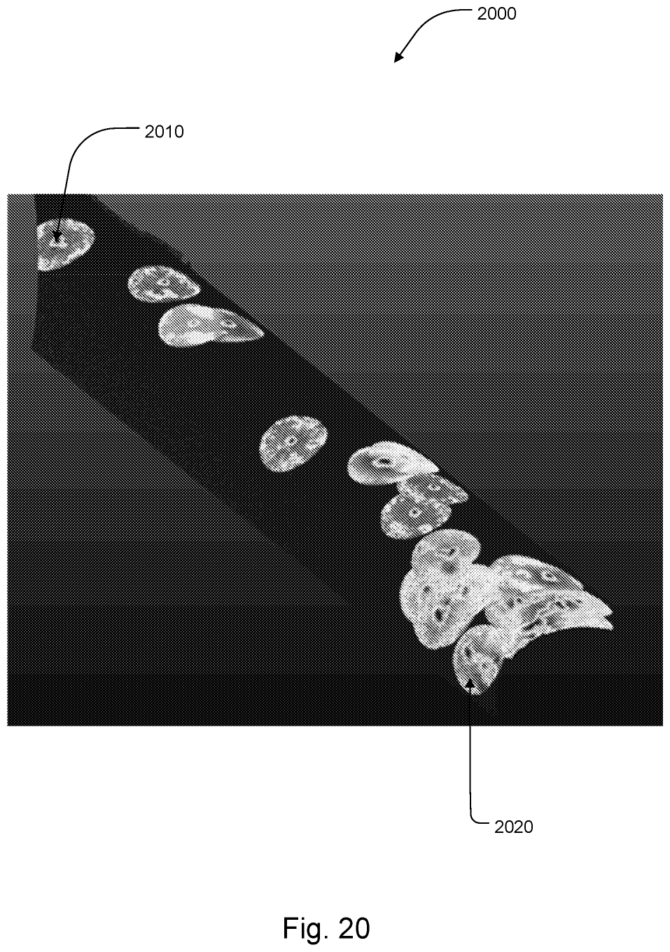

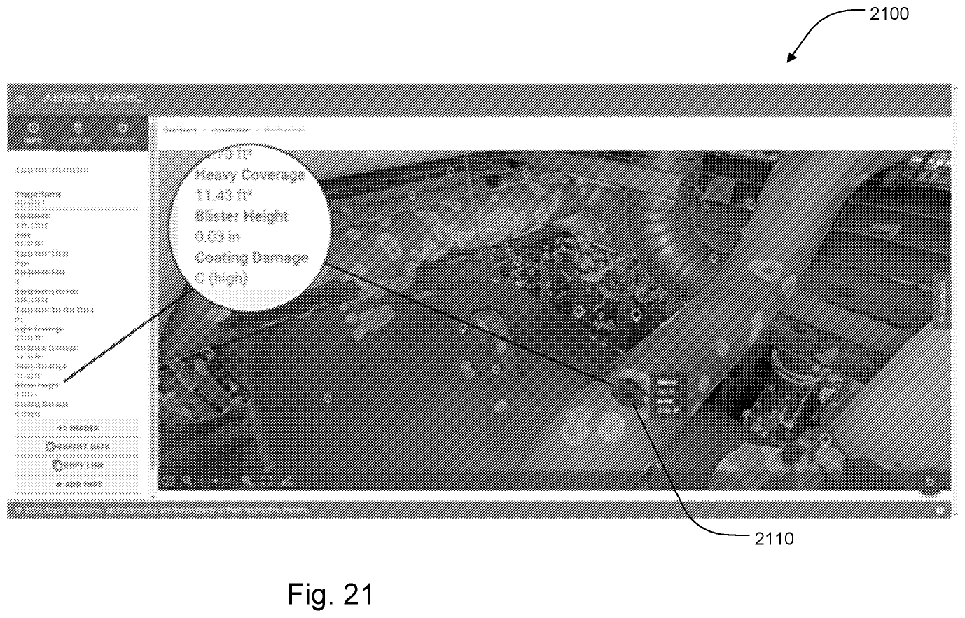

An example of a visual report 2000 of the output of point cloud of production asset 1700 may be seen in FIG. 20 where multiple surface deformations are coloured by the displacement value form the determine distance step 1660. A number of point clouds are shown for the asset in FIG. 20 such as region 1 2010 and region 2 2020. An example output 2100 is also shown in FIG. 21 which shows a portion of a production asset with point colour regions superimposed. Each of the point cloud regions have been processed by the point cloud of production asset 1700. Each of the point clouds has been coloured according to a maximum displacement as determined in the calculate maximum displacement step 1685. For example, the point clouds may be colour red for any region with a large displacement, orange for a medium displacement and grey for low displacement. The large, medium and low displacement values may be set by a user of the point cloud of production asset 1700 with threshold values. In one example a large displacement may be 6 mm or larger, a medium displacement between 3 mm and 6 mm while a low displacement is 3 mm or less. Alternatively, the regions may be ranked, according to a maximum displacement, and a selected percentage of regions may be marked as large, medium or low displacement. In one example, a low displacement may the first 40% of results, a medium displacement between 40% and 90% while large displacement is 90% or more. Such an approach may help to prioritize maintenance work. Selection of a region, such as region 2110 may bring up more data about the region. The data may include a maximum distance, a maximum positive distance, a maximum negative distance, area of the region as well as other information relating to the asset on which the region is located.

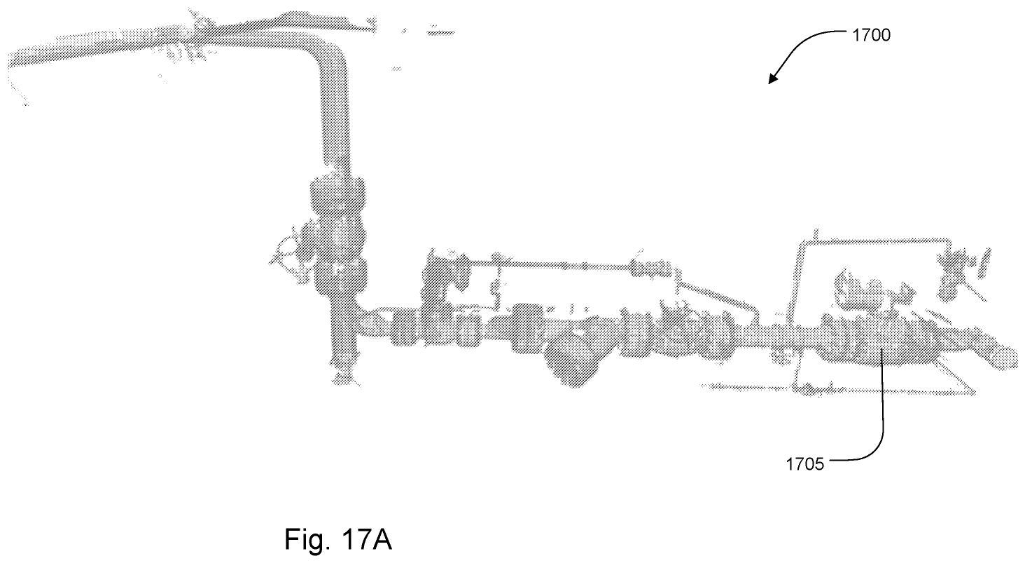

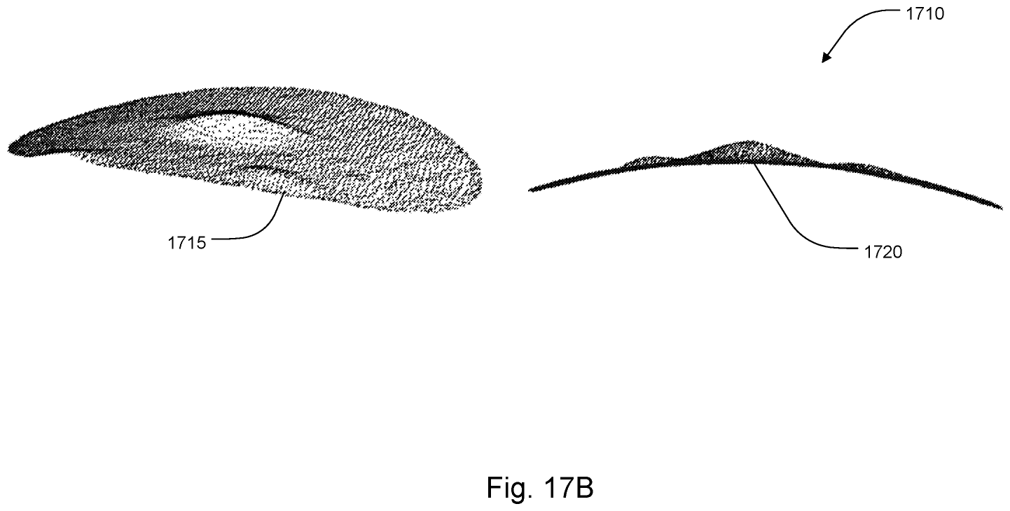

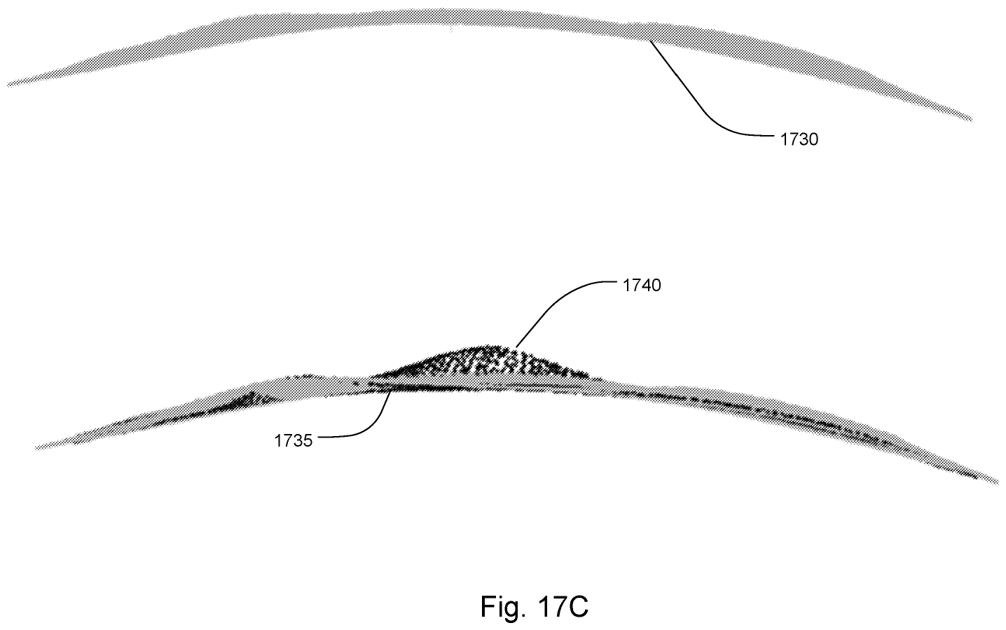

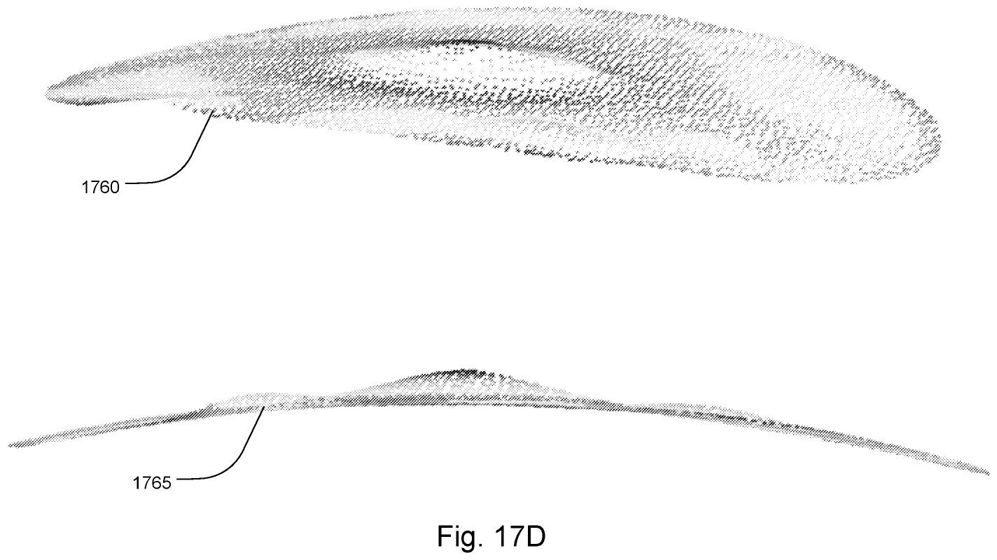

An example of the method of surface deformation detection 1600 described above will now be described with reference to FIGS. 17A, B and C. FIG. 17A shows a point cloud of a production asset 1700, in this case a pipe line with a number of valve and other components. The point cloud of FIG. 17A may be stored using Cartesian coordinate system (X, Y, Z), polar coordinate system (range, bearing, azimuth), or some other coordinate system. Shown on the point cloud of a production asset 1700 is a region of interest 1705

Each point in the point-cloud may also have additional information associated with each point such as: colour information captured by the image capture equipment, a distance values such as range-from-scanner or time-of-flight, or reflection characteristics such as intensity. The inspection data may be captured from a single or multiple inspection points. The 3D point cloud may be modified in some was such as filtered, cropped, interpolated, whole or partial, and contain all inspection data or only some of it. Other features may be added to each point, for example, an ID number relating to an instance of a type of requirement.

In a practical example: An offshore platform is comprehensively surveyed using cameras, and 3D image capture equipment. This includes the data capture of flat and/or panoramic images, 3D point-clouds, spatial metadata, localisation information for all data points (i.e., the inspection data). As the general data capture processes are already readily available as part of 3rd party services, it is not considered as part of the invention in this document.

FIG. 17B shows cropped regions 1710 which are examples of a 3D point cloud of the region of interest 1705. A cropped region 1715 has been selected using a predetermined radius R about a central point of the region of interest 1705 as described in the crop points step 1610. A rotated cropped region 1720 is also shown, where the cropped region 1715 has been rotated as described in align surface normal step 1630.

FIG. 17C shows a model surface 1730 that has been fitted to the rotated cropped region 1720 of FIG. 17B as described in the fit surface model step 1635. The model surface is an approximation of a surface of the points in the rotated cropped region 1720. However, the central raised region, visible in rotated cropped region 1720, is not present as the central raised region is considered a surface deformation from the original surface. Surface deformations are detected as a difference from the model surface. While the cause of the surface deformation may be unknown, identification of the surface deformation allows an inspection of the surface to collect further information. An overlaid model surface 1735 shows the rotated cropped region 1720 with the model surface 1730 superimposed. A central raised region 1740 protrudes from the model surface 1730.

FIG. 17D shows a displacement point cloud 1760 where colours of points in the cropped region 1715 have been modified based on a displacement calculated for each point as described in the method of surface deformation detection 1600. A side profile 1765 of the displacement point cloud 1760 is also shown.

In the method of surface deformation detection 1600 the loop between the select unprocessed point step 1645 and the check points step 1670 may be modified for an alternative, faster process that yields similar results. The point cloud may be uniformly sample to select sample x and sample y values within the point-cloud. The sample x and sample y values may be substitute into the estimated model surface to determine a z values for each of the sampled points. The x, y, z samples constitute a point-cloud version of the estimated model surface. A k-d tree may be constructed from the x, y, z samples. The k-d tree may be queried with points from the smoothed point-cloud, determined in the smooth points step 1640, to get a closest x, y, z sample to each point on the material surface point-cloud. That is, the closest point on the model surface. For each point in the point-cloud, the Euclidean distance is calculated between the point and a closest estimated model surface sample in the same way as performed in determine distance step 1660 by replacing xₘᵢₙ, yₘᵢₙ, zₘᵢₙ with the closest sample found in the k-d tree. The method of surface deformation detection 1600 continues from determine sign step 1665.

The error of the alternative process may reduce with an increase in a resolution of the uniformly sampled x and y values. However, increasing the resolution may increase the total processing time as the k-d tree contains more points.

In one example, the CAD information for a production asset may be used to generate the model surface. The CAD information may be used instead of, or in addition to, the process described above in relation to the method of surface deformation detection 1600.

One advantage of the described surface deformation detection system is that the system allows for automated measurement of displacement of surface deformations using a remotely located computer, without the need for the computer to be on site. Data captured on site using cameras and 3D image capture equipment may be sent to a processing centre off site.

The surface deformation detection system enables inspection engineers to gain fast and scalable insights from a facility so that the inspection engineers may prioritize and optimise their schedules for asset maintenance. The surface deformation detection system may also reduces the risk of missing severe deformations which can cause catastrophic failure of production assets, leading to costly shutdowns of the facility. The surface deformation detection system may also be applied to surfaces with different shapes, such as flat, gentle curves and sharp curves, with minimal human effort.

Optional embodiments may also be said to broadly include the parts, elements, steps and/or features referred to or indicated herein, individually or in any combination of two or more of the parts, elements, steps and/or features, and wherein specific integers are mentioned which have known equivalents in the art to which the invention relates, such known equivalents are deemed to be incorporated herein as if individually set forth.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1. A method of detecting surface deformation of a production asset, the method comprising:
receiving a point cloud for a surface of the production asset;
determining a model surface for the production asset from the point cloud, the model surface being an estimate of a deformation free representation of the surface of the production asset, the model surface being determined from points in the point cloud including points representing a surface deformation;
determining a distance between at least one point in the point cloud and the model surface; and
outputting the distance.

2. (canceled)

3. (canceled)

4. (canceled)

5. The method according to claim 1, further comprising:
smoothing points in the point cloud using locations of a plurality of neighbouring points in the point cloud.

6. (canceled)

7. The method according to claim 1, further comprising:
calculating a maximum distance between points in the point cloud and the model surface; and
associating the maximum distance with the production asset.

8. (canceled)

9. The method according to claim 1, wherein the model surface may be fitted to a curved surface and is a parameterised polynomial model.

10. The method according to claim 1, wherein the distance between the at least one point in the point cloud and the model surface is compensated for the model surface being determined from points in the point cloud including points representing the surface deformation.

11. The method according to claim 10, wherein the distance is compensated independent of a location of the at least one point in the point cloud.

12. The method according to claim 10, wherein the distance is compensated using a linear transform applied to an initial distance between the at least one point in the point cloud and the model surface.

13. (canceled)

14. The method according to claim 1, wherein the model surface is determined using a model selected from a plurality of models.

15. The method according to claim 14, wherein the plurality of models includes at least two models selected from the set including a parameterised polynomial model, a piecewise polynomial model and a rigid shape defined by a set of parameters.

16. The method according to claim 14, wherein each of the plurality of models is compared to the point cloud and the model is selected according to a best fit.

17. The method according to claim 1, wherein outputting the distance further comprises:
determining a maximum distance between point in the point cloud and the model surface;
classifying the point cloud for the surface according to the maximum distance; and
displaying the point cloud to a user according to the classification.

18. A system for detecting surface deformation of a production asset comprising at least one processing system configured to:
receive a point cloud for a surface of the production asset;
determine a model surface for production asset from the point cloud, the model surface being an estimate of a deformation free representation of the surface of the production asset, the model surface being determined from points in the point cloud including points representing a surface deformation; and
determine a distance between at least one point in the point cloud and the model surface; and
output the distance.

19. (canceled)

20. (canceled)

21. (canceled)

22. The system according to claim 18, wherein the at least one processing system is further configured to:
smooth points in the point cloud using locations of a plurality of neighbouring points in the point cloud.

23. (canceled)

24. The system according to claim 18, wherein the at least one processing system is further configured to:
calculate a maximum distance between points in the point cloud and the model surface; and
associating the maximum distance with the production asset.

25. (canceled)

26. The system according to claim 18, wherein the model surface may be fitted to a curved surface and is a parameterised polynomial model.

27. The system according to claim 18, wherein the at least one processing system is further configured to, when outputting the distance:
determine a maximum distance between point in the point cloud and the model surface;
classify the point cloud for the surface according to the maximum distance; and
display the point cloud to a user according to classification.

28. The system according to claim 18, wherein the distance between the at least one point in the point cloud and the model surface is compensated for the model surface being determined from points in the point cloud including the points representing the surface deformation.

29. The system according to claim 28, wherein the distance is compensated independent of a location of the at least one point in the point cloud.

30. The system according to claim 28, wherein the distance is compensated using a linear transform applied to an initial distance between the at least one point in the point cloud and the model surface.

31. (canceled)

32. The system according to claim 18, wherein the model surface is determined using a model selected from a plurality of models.

33. The system according to claim 32, wherein the plurality of models includes at least two models selected from the set including a parameterised polynomial model, a piecewise polynomial model and a rigid shape defined by a set of parameters.

34. The system according to claim 32, wherein each of the plurality of models is compared to the point cloud and the model is selected according to a best fit.
